(19) United States
(12) Patent Application Publication
(10) Pub. No.: US 2026/0120543 A1
(43) Pub. Date: Apr. 30, 2026

(54) SYSTEMS AND METHODS FOR CONTROLLING VISUALLY THEMATIC BONUS FEATURES OF ELECTRONIC WAGERING GAMES

(71) Applicant: Aristocrat Technologies, Inc., Las Vegas, NV (US)

(72) Inventors: Sara LaRocca, Reno, NV (US); Jennifer Mizzi, Ewa Beach, HI (US); NIcholas Farina, Granger, IN (US); Christopher Decker, Oakland, CA (US); Kelly Lockheed, Elkridge, MD (US)

(21) Appl. No.: 19/094,483

(22) Filed: Mar. 28, 2025

Related U.S. Application Data
(60) Provisional application No. 63/712,202, filed on Oct. 25, 2024.

(51) Int. Cl. G07F 17/32; G06F 7/58

(52) U.S. Cl. CPC G07F 17/3267; G06F 7/588; G07F 17/3213

(57) ABSTRACT

A system for controlling visually thematic bonus features of electronic wagering games may include and/or implement a display device and/or circuitry. In one example, the circuitry may be configured to direct the display device to render, in a graphical interface of an electronic wagering game, a plurality of metamorphic visuals and a meter visual that correspond to reels of the electronic wagering game. In this example, the circuitry may also be configured to detect an event that (1) triggers a bonus feature of the electronic wagering game in connection with at least one of the plurality of metamorphic visuals or the meter visual and (2) is based at least in part on a randomly generated number provided by a random number generator. The circuitry may be further configured to implement, in response to detecting the event, the bonus feature in accordance with a weighted lookup table stored in memory.

The present application claims priority to U.S. Provisional Patent Application No. 63/712,202, filed Oct. 25, 2024, which is hereby incorporated by reference in its entirety.

### BACKGROUND

### Background

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Other gaming establishments may provide Class II games, which are typically bingo-based games.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

As will be described in greater detail below, the instant disclosure generally relates to systems and methods for controlling visually thematic bonus features of electronic wagering games. In some examples, a system for accomplishing such a task may include and/or implement a display device and/or circuitry. In one example, the circuitry may be configured to direct the display device to render, in a graphical interface of an electronic wagering game, a plurality of metamorphic visuals and a meter visual that correspond to reels of the electronic wagering game. In this example, the circuitry may also be configured to detect an event that (1) triggers a bonus feature of the electronic wagering game in connection with at least one of the plurality of metamorphic visuals or the meter visual and (2) is based at least in part on a randomly generated number provided by an RNG. The circuitry may be further configured to implement, in response to detecting the event, the bonus feature in accordance with a weighted lookup table stored in memory.

In some examples, the circuitry may be further configured to detect, prior to the implementation of the bonus feature, one or more symbols of a certain type during a spin of the reels. In such examples, the event may include determining that the symbols of the certain type detected during the spin have increased a symbol count beyond a threshold. In one example, the circuitry may be further configured to detect one or more additional instances of the symbols on at least one of the reels during the bonus feature and to then direct the display device to render, in connection with the metamorphic visual, an amount visual that reflects a total amount to be awarded to a user based at least in part on the additional instances of the symbols detected during the bonus feature.

In some examples, the circuitry may be further configured to allot a certain number of spins to the user in connection with the bonus feature. In one example, the circuitry may be further configured to terminate the bonus feature upon determining that the user has completed the certain number of reel spins. In this example, the circuitry may be further configured to attribute, to the user, a value corresponding to the total amount reflected by the amount visual upon termination of the bonus feature.

In some examples, the circuitry may be further configured to detect one or more additional instances of the symbols on at least one of the reels during the bonus feature. In one example, the circuitry may be further configured to direct the display device to render, in connection with the at least one of the reels, a multiplier visual that reflects a multiplier value applied to one or more other instances of the symbols that land on the at least one of the reels during the bonus feature. In this example, the circuitry may be further configured to detect the other instances of the symbols on the at least one of the reels during the bonus feature and to then increase the multiplier value reflected by the multiplier visual in response to the other instances of the symbols being detected during the bonus feature. Additionally or alternatively, the circuitry may be configured to attribute, to a user, a value corresponding to the additional instances of the symbols and the other instances of the symbols as enhanced by the multiplier value.

In some examples, the circuitry may be further configured to detect, prior to the implementation of the bonus feature, activity that involves the reels and results from an interaction between a user and the electronic wagering game. In one example, the circuitry may be further configured to direct the display device to modify at least one of the metamorphic visuals prior to the implementation of the bonus feature based at least in part on the activity.

In some examples, the circuitry may be configured to detect, prior to the implementation of the bonus feature, activity that involves the reels and results from an interaction between a user and the electronic wagering game. In one example, the circuitry may be configured to direct the display device to modify at least one of the metamorphic visuals prior to the implementation of the bonus feature based at least in part on the activity. In this example, the metric may represent an amount of time since the electronic wagering game last awarded a previous instance of the bonus feature or a count of certain symbols that land during spins of the reels.

In some examples, the metamorphic visuals may include a plurality of graphical chests configured to fill with graphical objects commensurate with the metric. In one example, the circuitry may be further configured to modify the at least one of the metamorphic visuals by animating movement of a symbol that landed on one of the reels during a spin from the one of the reels toward one of the graphical chests. In certain implementations, the metamorphic visuals may include a graphical structure whose color changes commensurate with the metric.

In some examples, the event may include detecting the randomly generated number prior to the implementation of the bonus feature and determining that the randomly generated number matches a certain number associated with the bonus feature. In one example, the circuitry may be further configured to detect at least one metric that represents actual progress toward unlocking the bonus feature in connection with the meter visual and to then direct the display device to modify the meter visual commensurate with the metric.

In some examples, the circuitry may be further configured to detect, prior to the implementation of the bonus feature, symbols of multiple types during a spin of the reels. In such examples, the event may include determining that the symbols of the multiple types detected during the spin have increased symbol counts corresponding to the multiple types beyond at least one threshold.

In some examples, the circuitry may be further configured to detect an additional symbol on at least one of the reels during the bonus feature and to then direct the display device to expand at least one dimension of the reels to increase a number of positions available on the reels during subsequent spins based at least in part on the additional symbol. In one example, the circuitry may be further configured to detect one or more other symbols on at least one of the reels during the bonus feature and to then implement an additional bonus feature in conjunction with the bonus feature in response to detecting the other symbols.

Similarly, a corresponding computer-implemented method may include directing, by circuitry included in a computing system, a display device to render a plurality of metamorphic visuals and a meter visual that correspond to reels of an electronic wagering game in the graphical user interface. In some examples, the computer-implemented method may include detecting, by the circuitry, an event that (1) triggers a bonus feature of the electronic wagering game in connection with at least one of the plurality of metamorphic visuals or the meter visual and (2) is based at least in part on a randomly generated number provided by an RNG. Additionally or alternatively, the computer-implemented method may include implementing, by the circuitry in response to detecting the event, the bonus feature in accordance with a weighted lookup table stored in memory.

In some examples, a non-transitory computer-readable medium that facilitates and/or implements the above-identified method may include one or more computer-executable instructions. When executed by at least one hardware processor of a computing device, the computer-executable instructions may cause the hardware processor to direct a display device to render a plurality of metamorphic visuals and a meter visual that correspond to reels of an electronic wagering game in the graphical user interface. In one example, when executed by the hardware processor of the computing device, the computer-executable instructions may also cause the hardware processor to detect an event that (1) triggers a bonus feature of the electronic wagering game in connection with at least one of the plurality of metamorphic visuals or the meter visual and (2) is based at least in part on a randomly generated number provided by an RNG. In this example, when executed by the hardware processor of the computing device, the computer-executable instructions may also cause the hardware processor to implement, in response to detecting the event, the bonus feature in accordance with a weighted lookup table stored in memory.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an exemplary diagram showing several electronic gaming machines (EGMs) networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram of an exemplary system for controlling visually thematic bonus features of electronic wagering games according to one or more implementations of this disclosure.

FIG. 5 is an illustration of an exemplary scene of gameplay rendered on a graphical interface of an electronic wagering game according to one or more implementations of this disclosure.

FIG. 6 is an illustration of an exemplary scene of gameplay rendered on a graphical interface of an electronic wagering game according to one or more implementations of this disclosure.

FIG. 7 is an illustration of an exemplary scene of gameplay rendered on a graphical interface of an electronic wagering game according to one or more implementations of this disclosure.

FIG. 8 is an illustration of an exemplary scene of gameplay rendered on a graphical interface of an electronic wagering game according to one or more implementations of this disclosure.

FIG. 9 is an illustration of an exemplary scene of gameplay rendered on a graphical interface of an electronic wagering game according to one or more implementations of this disclosure.

FIG. 10 is an illustration of an exemplary scene of gameplay rendered on a graphical interface of an electronic wagering game according to one or more implementations of this disclosure.

FIG. 11 is an illustration of an exemplary scene of gameplay rendered on a graphical interface of an electronic wagering game according to one or more implementations of this disclosure.

FIG. 12 is an illustration of an exemplary scene of gameplay rendered on a graphical interface of an electronic wagering game according to one or more implementations of this disclosure.

FIG. 13 is an illustration of an exemplary scene of gameplay rendered on a graphical interface of an electronic wagering game according to one or more implementations of this disclosure.

FIG. 14 is an illustration of an exemplary scene of gameplay rendered on a graphical interface of an electronic wagering game according to one or more implementations of this disclosure.

FIG. 15 is an illustration of an exemplary scene of gameplay rendered on a graphical interface of an electronic wagering game according to one or more implementations of this disclosure.

FIG. 16 is an illustration of an exemplary scene of gameplay rendered on a graphical interface of an electronic wagering game according to one or more implementations of this disclosure.

FIG. 17 is an illustration of an exemplary scene of gameplay rendered on a graphical interface of an electronic wagering game according to one or more implementations of this disclosure.

FIG. 18 is an illustration of an exemplary scene of gameplay rendered on a graphical interface of an electronic wagering game according to one or more implementations of this disclosure.

FIG. 19 is an illustration of an exemplary scene of gameplay rendered on a graphical interface of an electronic wagering game according to one or more implementations of this disclosure.

FIG. 20 is an illustration of an exemplary scene of gameplay rendered on a graphical interface of an electronic wagering game according to one or more implementations of this disclosure.

FIG. 21 is an illustration of an exemplary scene of gameplay rendered on a graphical interface of an electronic wagering game according to one or more implementations of this disclosure.

FIG. 22 is an illustration of an exemplary scene of gameplay rendered on a graphical interface of an electronic wagering game according to one or more implementations of this disclosure.

FIG. 23 is a flow diagram of an exemplary computer-implemented method for controlling visually thematic bonus features of electronic wagering games according to one or more implementations of this disclosure.

Throughout the drawings, identical reference characters and descriptions may indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the instant disclosure are generally directed to controlling visually thematic bonus features of electronic wagering games. In some examples, the electronic gaming systems may include and/or represent an EGM equipped with a display, one or more input devices, a wager acceptor, and/or a game controller coupled to the display, the input devices, and/or the wager acceptor. The game controller may be configured to control the display to present and/or display an electronic wagering game. The game controller may present and/or display these various wager options in the electronic wagering game.

In some examples, the electronic wagering game may be governed by different rules and/or pay tables (e.g., weighted lookup tables). In one example, the game controller may be configured to operate the electronic wagering game using a common wagering event (e.g., a reel spin). The game controller may also enable users to make certain selections (e.g., wager selections) in the electronic wagering game.

In some examples, an electronic wagering system may implement a graphical slot machine that includes and/or represents a set of reels that spin in connection with a user's wager. In one example, the graphical slot machine may include and/or represent a set of metamorphic visuals (e.g., graphical chests that fill with graphical objects, a graphical crystal structure whose color changes commensurate with the metric, etc.) whose status and/or condition depicts the user's apparent and/or actual progress toward unlocking a bonus mode and/or feature, such as a free-games feature and/or a hold-and-spin feature. For example, one or more metrics and/or measurements may indicate and/or represent a duration and/or an amount of time since the graphical slot machine last awarded and/or granted a corresponding bonus feature to a user. In this example, one or more of the metamorphic visuals may depict and/or graphically represent the duration and/or amount of time that has passed and/or elapsed since the graphical slot machine last awarded and/or granted the corresponding bonus feature to a user.

In some examples, the metrics and/or measurements may correspond to, represent, and/or be associated with the user's performance, apparent progress, and/or wagers while playing the graphical slot machine. In one example, the metamorphic visuals may depict and/or graphically represent the user's performance, apparent progress, and/or wagers commensurate with the metrics and/or measurements.

Additionally or alternatively, the graphical slot machine may include and/or display a meter visual that corresponds to a metric that represents and/or corresponds to actual and/or perceived progress toward unlocking the bonus feature. In some examples, the graphical slot machine may detect certain symbols, such as cash-on-reel (COR) symbols, that land on the reels during spins in a base mode. In one example, the graphical slot machine may determine that those symbols detected during the spins have increased a symbol count corresponding to those symbols beyond a certain threshold. In this example, the graphical slot machine may present, display, and/or update the meter visual to track, parallel, and/or increase commensurate with that symbol count.

In some examples, as the metrics and/or measurements increase, so too may the corresponding metamorphic visuals. For example, as a user plays a graphical slot machine, metrics representing the duration since the last awarded bonus may increase. In this example, metamorphic visuals depicted in the graphical slot machine may reflect, follow, and/or parallel the status and/or condition of such metrics. In one example, once one or more of the metrics reaches a certain threshold, the graphical slot machine may award and/or grant a corresponding bonus mode and/or feature to the user. In certain implementations, the graphical slot machine may apply and/or perform one or more visual effects and/or animations to indicate and/or reflect the award and/or grant of the bonus mode and/or feature. For example, the graphical slot machine may animate the symbols that land on the reels and/or the corresponding metamorphic visuals in one way or another (e.g., graphical objects launching and/or shooting from the reels toward the corresponding metamorphic visual, a graphical explosion or illumination on or around the corresponding metamorphic, a color change on a graphical crystal structure, etc.) in response to the award and/or grant of the bonus mode and/or feature.

In some examples, the metamorphic visuals may stay and/or remain active in a similar or identical way throughout implementation of the bonus mode and/or feature. For example, the metamorphic visuals may reflect the symbol count of a certain symbol that lands on the reels during the implementation of the bonus mode and/or feature. In one example, the graphical slot machine may award and/or grant a win-all, collect-all, and/or roll-up during the implementation of the bonus mode and/or feature. In certain implementations, as part of this win-all, collect-all, and/or roll-up, the graphical slot machine may give the value of COR symbols that appeared on the reels to the user before the bonus mode and/or feature ends. Additionally or alternatively, upon termination of the bonus feature, the graphical slot machine may revert and/or return to the base mode.

In some examples, each COR symbol that appears on the reels during the implementation of the bonus feature may correspond to and/or represent at least one value (e.g., a monetary value and/or credit). In one example, the COR symbols may each include and/or represent multiple values corresponding to the different metamorphic visuals. For example, one value represented by a COR symbol may correspond to a metamorphic visual depicted on one side of the graphical slot machine, another value represented by another COR symbol may correspond to another metamorphic visual depicted on another side of the graphical slot machine, and a further value represented by a further COR symbol may correspond to a further metamorphic visual depicted between the other two metamorphic visuals of the graphical slot machine. Accordingly, when the win-all, collect-all, and/or roll-up is awarded and/or granted, the graphical slot machine may attribute, to the user, the total value of all the COR symbols that land during the bonus feature.

In some examples, the graphical slot machine may award and/or implement multiple bonus features simultaneously in response to one or more events. For example, if the symbol counts corresponding to multiple types of symbols increase beyond a certain threshold simultaneously during a spin, then the graphical slot machine may award and/or implement a dual-bonus mode and/or feature during which COR symbols of multiple types lead to value awards corresponding to multiple metamorphic visuals. In one example, during the implementation of one bonus mode and/or feature, the graphical slot machine may additionally award and/or implement a further bonus mode and/or feature. In this example, as a result, the graphical slot machine may execute and/or implement one bonus mode and/or feature within another one. Accordingly, combinations of the bonus features described herein may be available, offered, and/or played out simultaneously on the graphical slot machine.

Some electronic wagering systems may suffer from certain technical problems and/or deficiencies that impair the functionality of the underlying EGMs and/or the users' experiences and/or enjoyment of the electronic wagering game. The various systems and methods disclosed herein may address one or more of those technical problems, which include at least one of (1) an inability to regulate, control, and/or account for the degree of randomness associated with various visually thematic bonus features, (2) an inability to provide and/or promote a suitable RTP that ensures the EGMs' long-term suitability and/or viability in view of the various visually thematic bonus features, (3) an inability to configure triggers for the various visually thematic bonus features by dynamically accounting for tiered wagering, past payouts, and/or current totals in view of the probabilities associated with random number generation provided by RNGs, (4) an inability to control the speeds and/or metamorphic progression at which base games and/or bonus features transition or progress from one state reflected by a metamorphic to a higher state reflected by the metamorphic while maintaining and/or achieving a suitable RTP and/or game volatility, and/or (5) an inability to effectively communicate the progression and/or activation of one or more visually thematic bonus features among a variety of options and/or possibilities.

Accordingly, the various systems and methods disclosed herein may address and/or resolve one or more of those technical problems by providing corresponding solutions, which include at least one of (1) an ability to regulate, control, and/or account for the degree of randomness associated with various visually thematic bonus features, (2) an ability to provide and/or promote a suitable RTP that ensures the EGMs' long-term suitability and/or viability in view of the various visually thematic bonus features, (3) an ability to configure triggers for the various visually thematic bonus features by dynamically accounting for tiered wagering, past payouts, and/or current totals in view of the probabilities associated with random number generation provided by RNGs, (4) an ability to control the speeds and/or metamorphic progression at which base games and/or bonus features transition or progress from one state reflected by a metamorphic to a higher state reflected by the metamorphic while maintaining and/or achieving a suitable RTP and/or game volatility, and/or (5) an inability to effectively communicate the progression and/or activation of one or more visually thematic bonus features among a variety of options and/or possibilities.

In some examples, the various systems and methods disclosed herein may control the degree of randomness and/or provide a suitable RTP by configuring, tailoring, and/or tuning the parameters of weighted lookup tables. In one example, such weighted lookup tables may account for the different risks and/or volatilities associated with the various visually thematic bonus features. Accordingly, the various systems and methods disclosed herein may improve EGMs by preventing excessive payouts resulting from variation across the risks and/or volatilities associated with the visually thematic bonus features over long periods of time.

In some examples, an EGM may be unable to effectively communicate and/or convey that certain bonuses (e.g., win-alls, collect-alls, and/or roll-ups) have been awarded and/or granted to users throughout gameplay-especially in loud environments like casinos. The EGM may address, resolve, and/or mitigate some of these technical problems and/or deficiencies. For example, a graphical slot machine implemented by the EGM may effectively communicate and/or convey certain occurrences and/or events (e.g., the free-games award and/or the win-all, collect-all, and/or roll-up) through visual effects and/or animations applied to and/or implemented by the metamorphic visuals.

As a specific example, the graphical slot machine may coordinate and/or synchronize win-alls, collect-alls, and/or roll-ups with certain visual effects and/or animations that are applied to and/or implemented by the metamorphic visuals and/or corresponding symbols. By doing so, the graphical slot machine may be able to effectively communicate and/or convey, to users, that the users have been awarded such win-alls, collect-alls, and/or roll-ups-even in loud environments like casinos. Otherwise, the users may struggle to comprehend what is actually happening in the gameplay of the graphical slot machine and/or with the users' wagering, and such struggles may impair the users' experiences and/or enjoyment with the graphical slot machine. Accordingly, the graphical slot machine's coordination between the metamorphic visuals and the win-alls, collect-alls, and/or roll-ups substantially solves the communication and/or conveyance problem relating to the users' comprehension of what is actually happening in the gameplay.

Some embodiments of the present disclosure constitute and/or represent a technical improvement in the art of EGMs and their operations. For example, an improved EGM may dynamically trigger a bonus feature based at least in part on a number generated by a random number generator. Unfortunately, game design challenges may arise when implementing bonus features in connection with metamorphic visuals and/or meter visuals. As an example, when visually thematic bonus features are triggered by an event, certain characteristics of such bonus features (e.g., expanded reel dimensions, multipliers, rollup awards, etc.) may cause an EGM to make high payouts that potentially exceed the permissible RTP, thereby potentially rendering the EGM unsuitable for gameplay and/or ruining the long-term viability of the EGM.

In some examples, these challenges necessitate additional controls for regulating the visually thematic bonus features to address changes in RTP volatility and/or to achieve a suitable RTP across such bonus features. Some embodiments of the present disclosure may improve the technical capability and/or long-term viability of EGMs that implement visually thematic bonus features by accounting for the higher payout risks associated with such bonus features over long periods of time. For example, an improvement in gaming machine capability may occur through operational advantages of configuring a bonus game trigger by dynamically accounting for tiered wagering, past payouts, and/or current totals in view of the probabilities associated with random number generation provided by RNGs. By doing so, this improved gaming machine capability may enable an EGM to trigger and/or activate a bonus feature, to determine a number of reel spins offered with the bonus feature, to change weighted lookup tables and/or reels for determining wins and/or awards during the bonus feature, etc.

Some challenges may also occur in base game and/or bonus feature progressions. For example, an improvement in game machine capability may occur through operational advantages of controlling the speeds and/or metamorphic progression at which base games and/or bonus features transition or progress from one state to a higher state while maintaining and/or achieving a suitable RTP and/or game volatility. In one example, the metamorphic progression and/or speed may be controlled such that higher paying variations access higher states slower or quicker. In another example, the metamorphic progression and/or speed may be controlled by providing additional states such that the transition from a lower state to the highest state takes longer.

Some embodiments described herein may be provided in combination or in isolation to summarize and/or present game mechanics in a way that improves the efficiency of an EGM's computer and/or display. For example, an EGM may provide an improved user interface that displays a limited set of information to players, potentially within a small screen, such that players are able to more quickly understand the current status of the game. In this example, the EGM's improved display functionality may provide multiple visual indicators that communicate the game mechanics to players. Additionally or alternatively, the EGM's improved display functionality may provide increased efficiency by eliminating the need for complex information pages describing game mechanics to players. In other words, because the visually thematic bonus features include and/or represent easily understandable animations, symbols, and/or indicators, the underlying games may be understood and/or played on a single screen that is substantially smaller than those of certain EGMs (e.g., games played on a mobile device like a smartphone), thereby potentially eliminating the need for multiple displays with complex information interfaces that present lengthy text.

By generating and storing visually thematic presentations for selection according to the various embodiments disclosed herein, an EGM may reduce the amount of computations and/or determinations by the EGM and/or a corresponding server during gameplay. By doing so, the EGM may be able to achieve and/or implement gains in computer efficiency and/or savings in computer resources. In other words, the EGM may facilitate and/or support the generation and/or storage of visually thematic presentations that ultimately require fewer computations and/or determinations for implementation during gameplay over the life of the EGM.

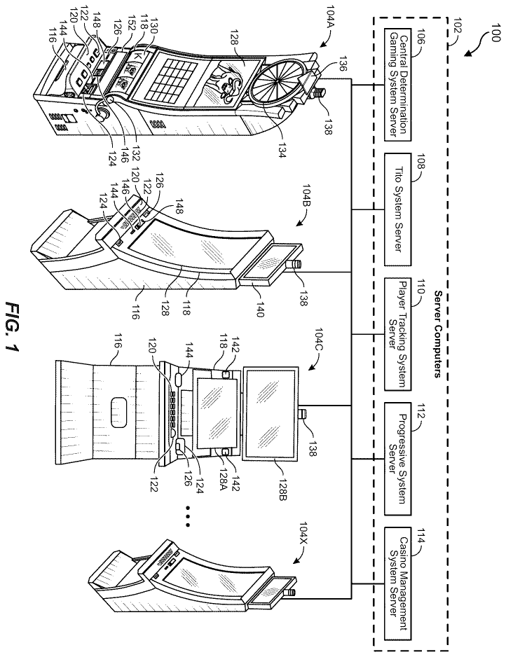

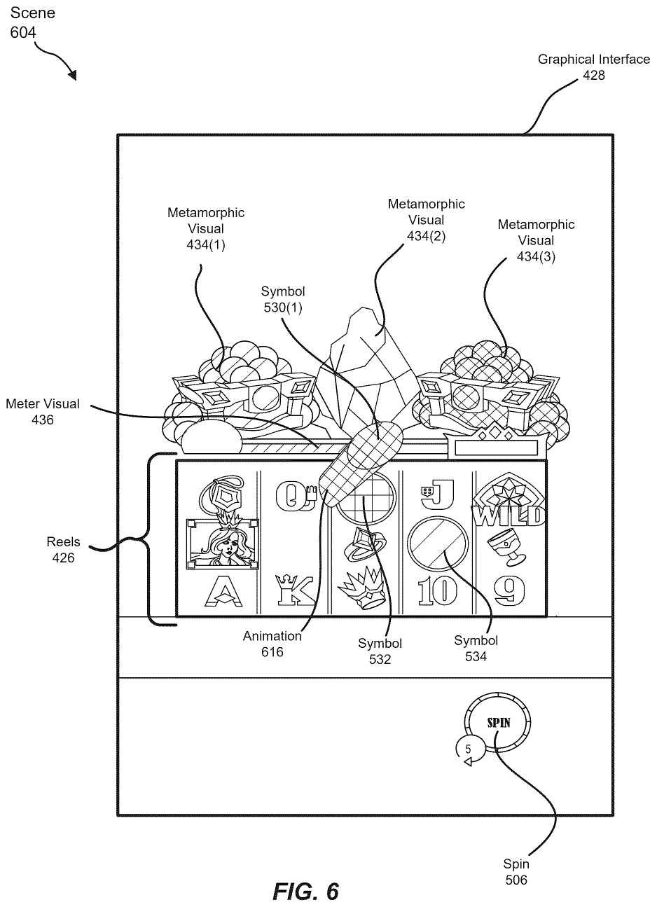

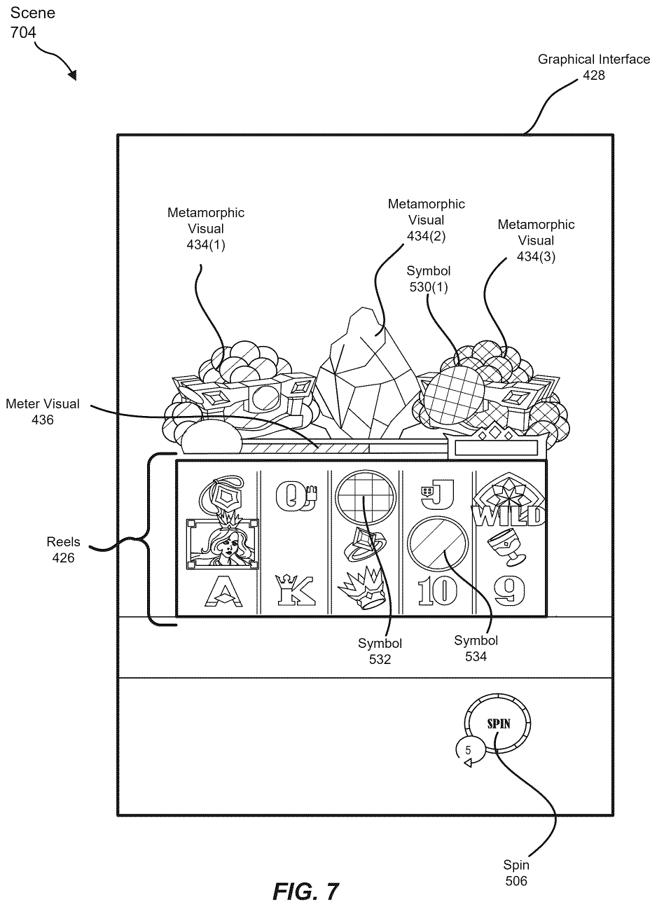

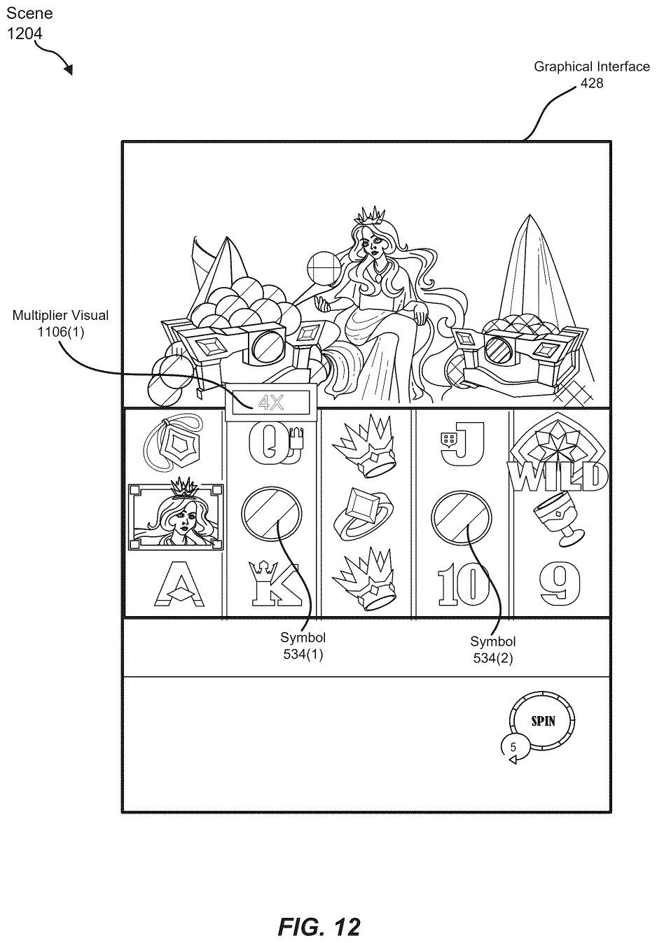

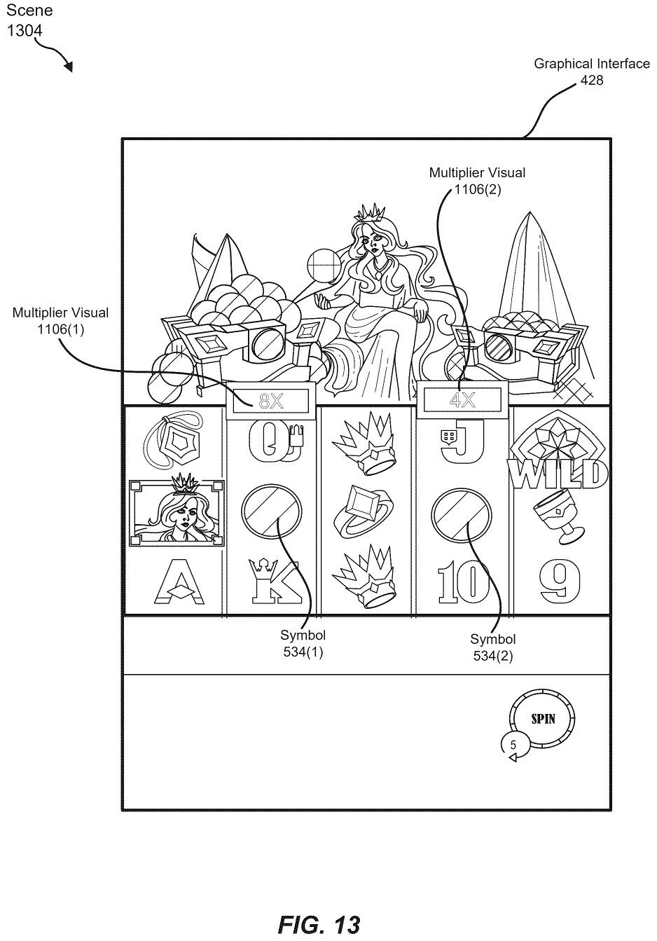

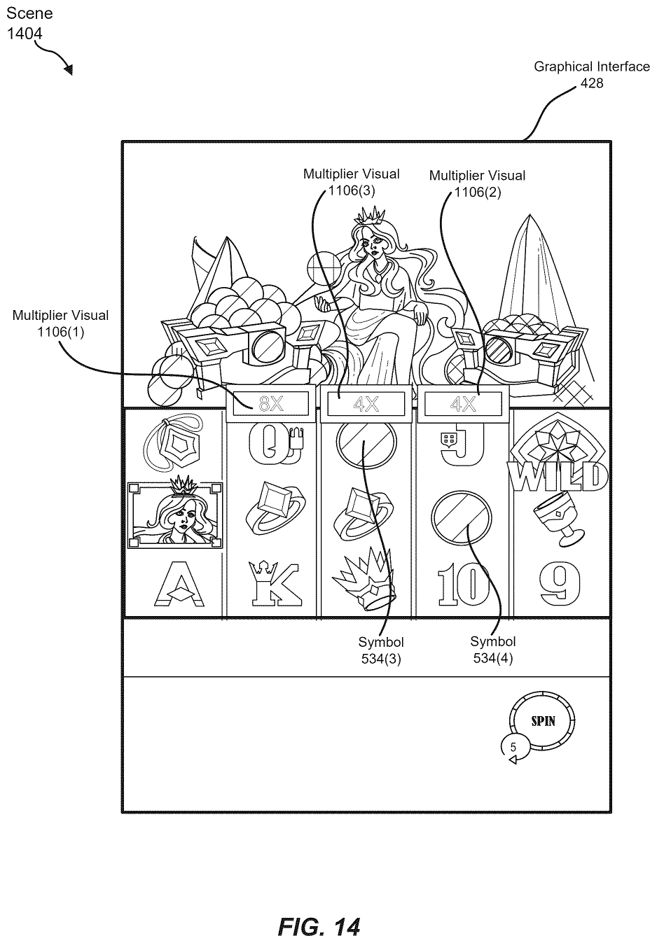

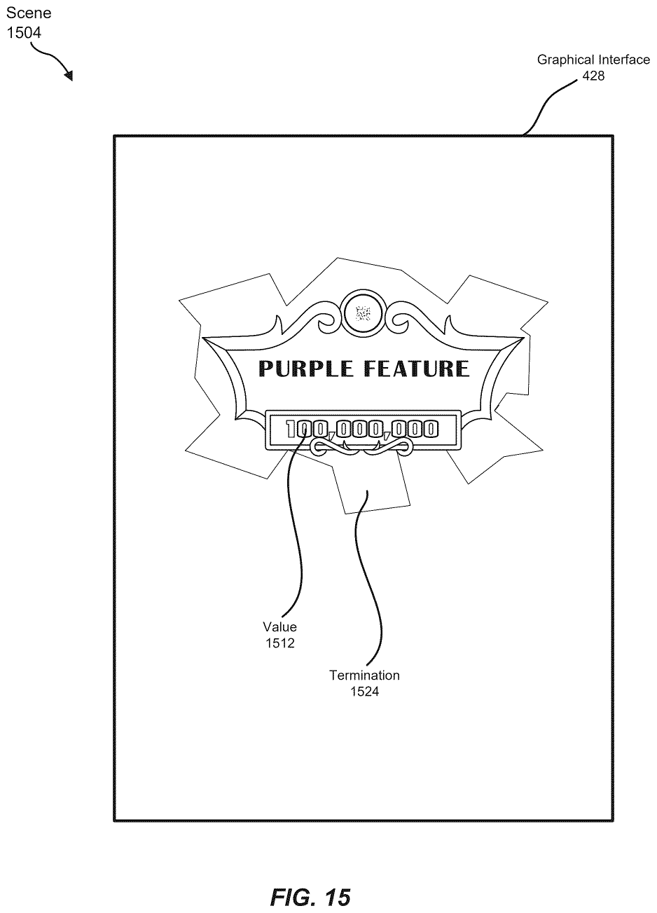

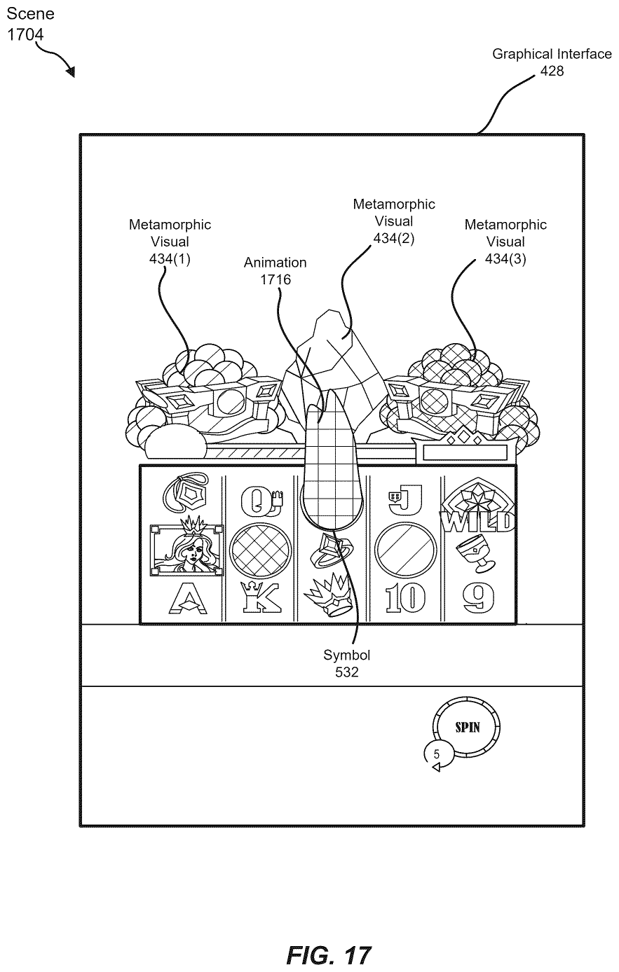

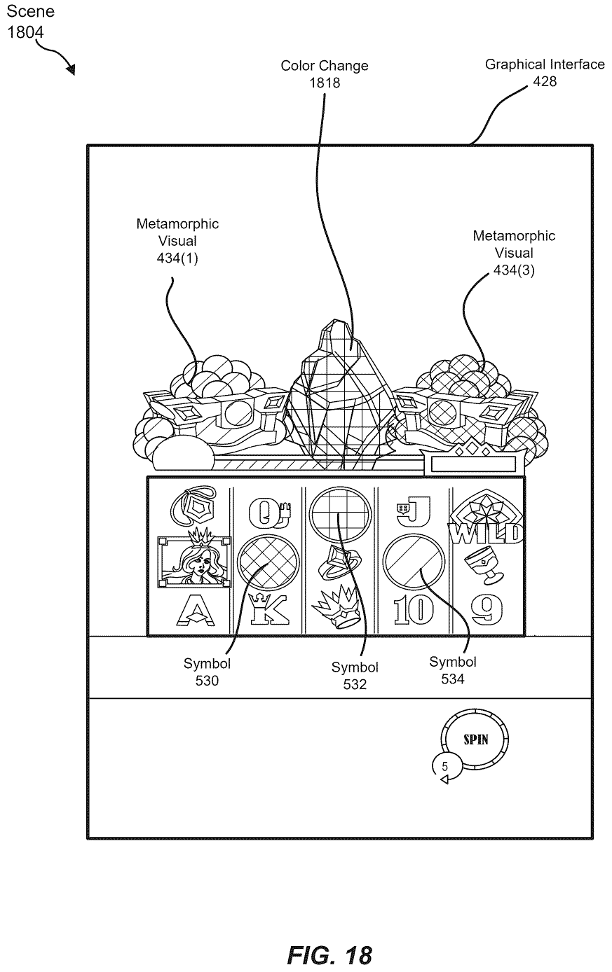

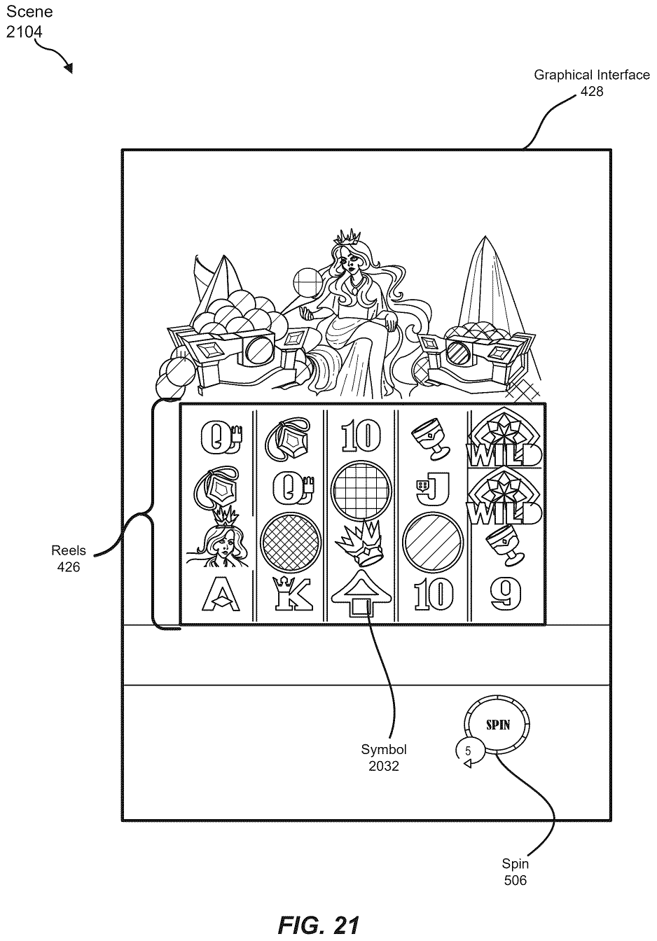

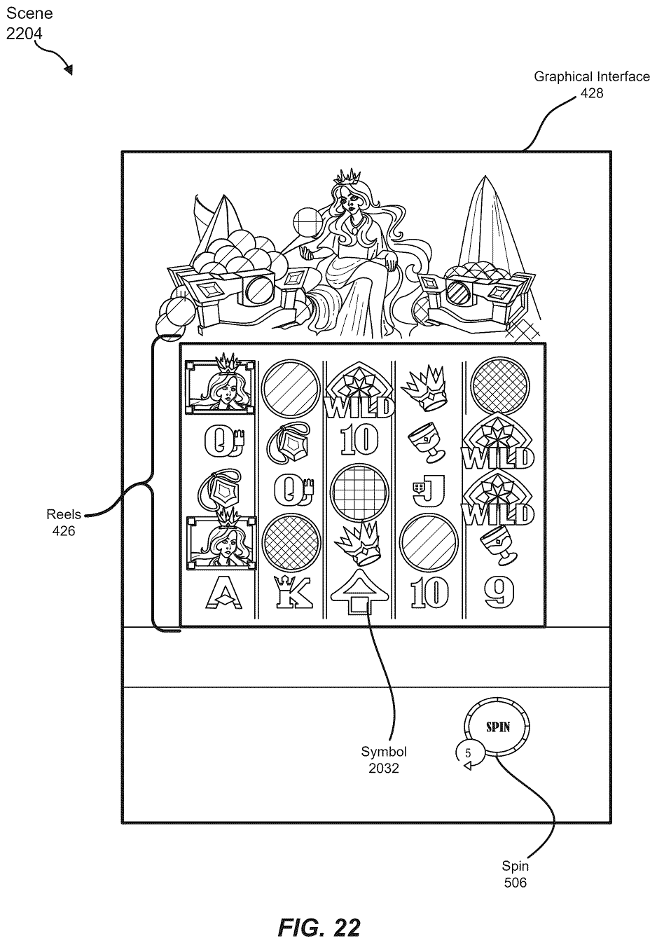

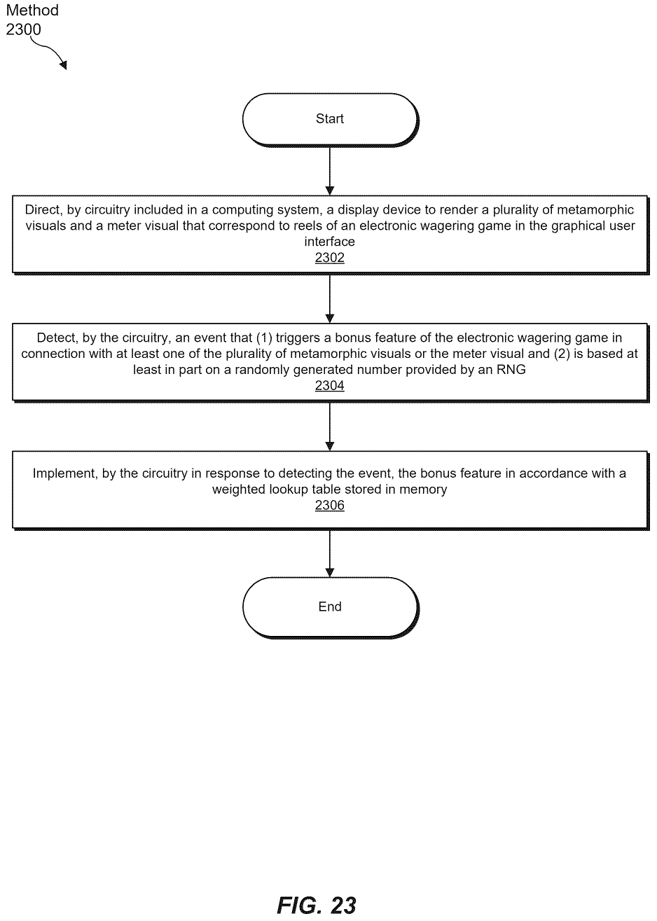

The following will provide, with reference to FIGS. 1-22, detailed descriptions of exemplary apparatuses, devices, systems, components, configurations, features, or implementations for controlling visually thematic bonus features of electronic wagering games. In addition, detailed descriptions of methods for controlling visually thematic bonus features of electronic wagering games will be provided in connection with FIG. 23.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate gameplay.

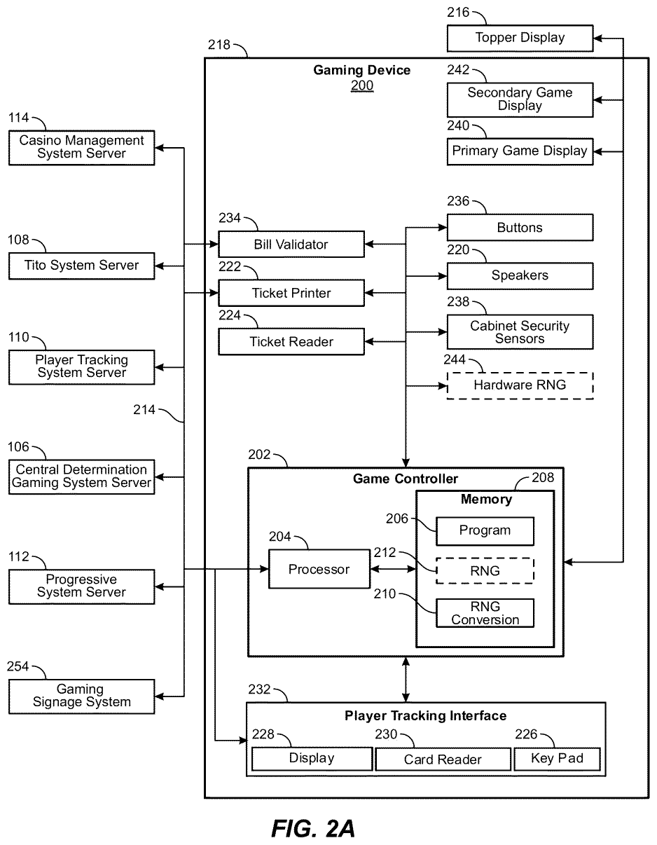

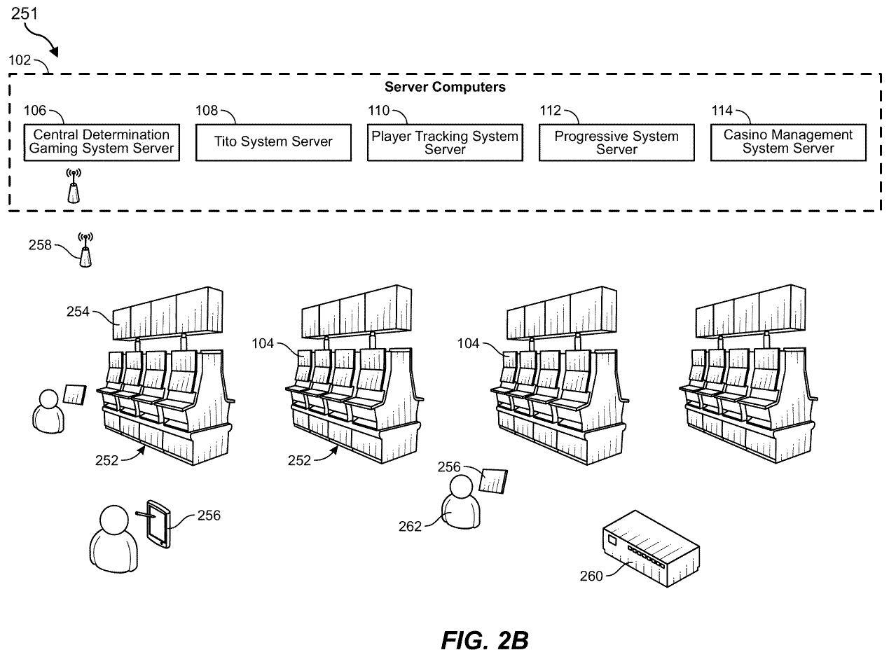

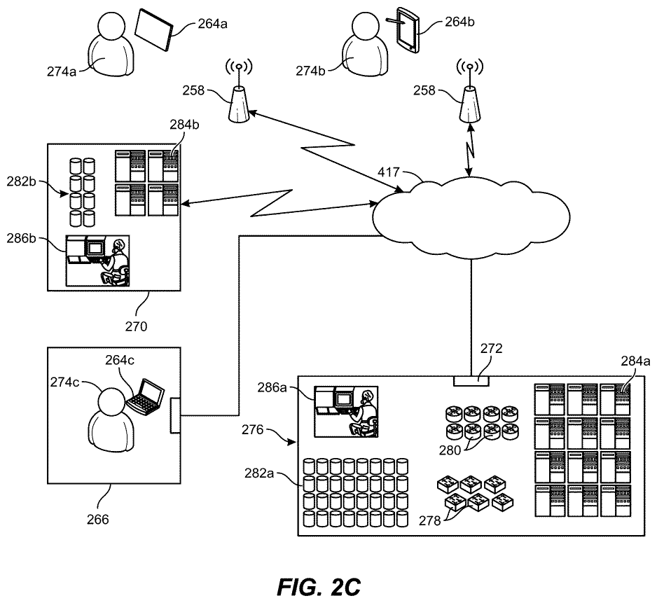

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows gameplay functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary gameplay while secondary display 128B is typically used for bonus gameplay, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of gameplays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of gameplay (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online gameplay. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online gameplay, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

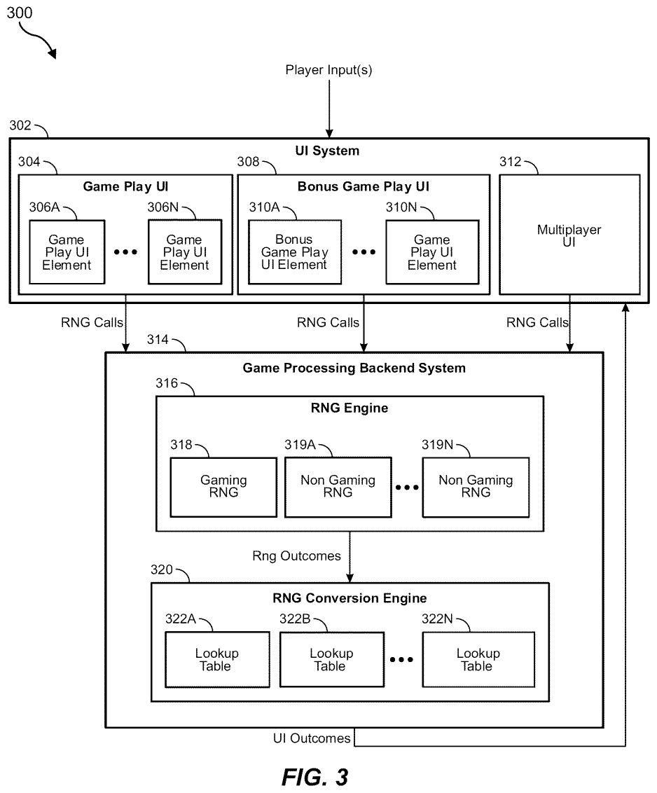

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more gameplay UIs 304, one or more bonus gameplay UIs 308, and one or more multiplayer UIs 312, where each UI type includes one or more mechanical UIs and/or graphical UIs (GUIs). In other words, gameplay UI 304, bonus gameplay UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present gameplay to a player. Using FIG. 3 as an example, the different UI elements are shown as gameplay UI elements 306A-306N and bonus gameplay UI elements 310A-310N.

The gameplay UI 304 represents a UI that a player typically interfaces with for a base game. During a game instance of a base game, the gameplay UI elements 306A-306N (e.g., GUI elements depicting one or more virtual reels) are shown and/or made available to a user. In a subsequent game instance, the UI system 302 could transition out of the base game to one or more bonus games. The bonus gameplay UI 308 represents a UI that utilizes bonus gameplay UI elements 310A-310N for a player to interact with and/or view during a bonus game. In one or more implementations, at least some of the gameplay UI element 306A-306N are similar to the bonus gameplay UI elements 310A-310N. In other implementations, the gameplay UI element 306A-306N can differ from the bonus gameplay UI elements 310A-310N.

FIG. 3 also illustrates that UI system 302 could include a multiplayer UI 312 purposed for gameplay that differs or is separate from the typical base game. For example, multiplayer UI 312 could be set up to receive player inputs and/or presents gameplay information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament gameplay. After tournament gameplay ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for gameplay. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more gameplay UI elements 306A-306N, such as symbols, for the gameplay UI 304. In another example, if the UI outcome is for a bonus game, the UI system could update one or more bonus gameplay UI elements 310A-310N (e.g., symbols) for the bonus gameplay UI 308. In response to updating the appropriate UI, the player may subsequently provide additional player inputs to initiate a subsequent game instance that progresses through the game processing pipeline.

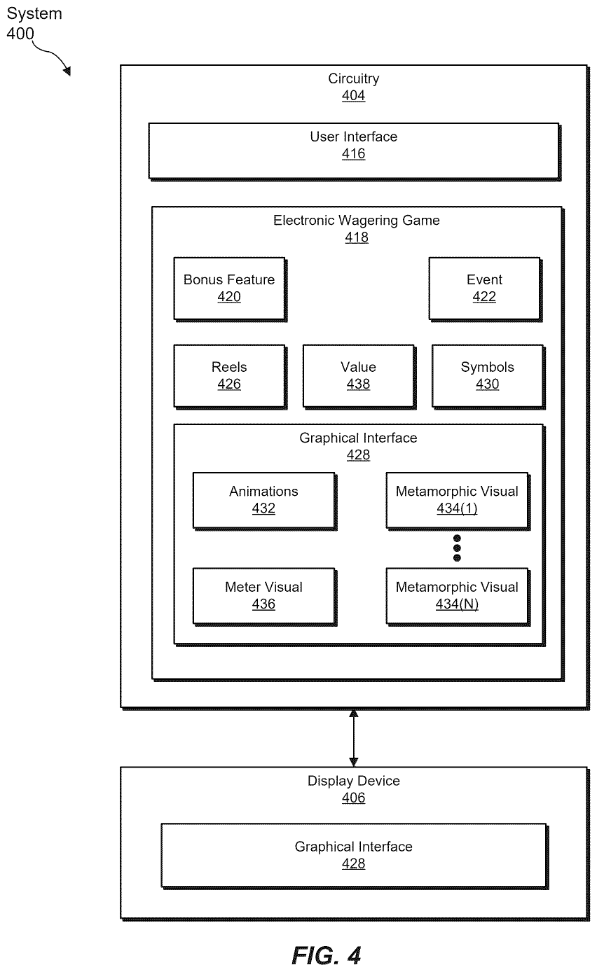

FIG. 4 illustrates an exemplary system 400 for controlling visually thematic bonus features of electronic wagering games. In some examples, thematic visuals may refer to, include, and/or represent meter visuals and/or metamorphic visuals that correspond to and/or are affected by certain symbols (e.g., COR symbols) that land on the reels of an electronic wagering game. Additionally or alternatively, such thematic visuals may refer to, include, and/or represent animations and/or visual effects that reflect and/or are triggered by certain events involving such symbols that land on the reels.

As illustrated in FIG. 4, system 400 may include and/or represent circuitry 404 and display device 406. In some examples, circuitry 404 may implement and/or execute an electronic wagering game 418 in conjunction with display device 406. In one example, circuitry 404 may include and/or represent a user interface 416 that enables a user to enter and/or provide input in connection with electronic wagering game 418. In this example, circuitry 404 may direct and/or cause display device 406 to render and/or present a graphical interface 428 of electronic wagering game 418 for viewing by the user.

In some examples, electronic wagering game 418 may include and/or represent reels 426 configured to spin in connection with wagers made by the user. In one example, reels 426 may include and/or represent symbols 430 that spin, rotate, and/or change during gameplay. For example, each of reels 426 may rotate a set of symbols vertically during gameplay. In this example, certain combinations and/or sequences of symbols 430 across reels 426 may constitute a win and/or increase for the user. As a result, the electronic wagering game 418 may award and/or grant, to the user, a certain monetary value and/or credit associated with one or more of symbols 430 and/or their corresponding combinations or sequences. In certain implementations, some of symbols 430 may be differentiated from one another by visual characteristics (e.g., size, color, patterns, textures, etc.) and/or by values (e.g., 100, 200, 300, etc.).

In some examples, graphical interface 428 of electronic wagering game 418 may include and/or represent one or more metamorphic visuals 434(1)-(N). In one example, metamorphic visuals 434(1)-(N) may include and/or represent graphical objects that represent certain features and/or attributes of the gameplay, such as values and/or credits accumulated by one or more users, increments on progressives, durations and/or amounts of time since the last time a certain bonus was awarded, etc. In this example, metamorphic visuals 434(1)-(N) may include and/or represent perceived-persistence graphics, quasi-persistence graphics, pseudo-persistence graphics, and/or true-persistence graphics.

In some examples, circuitry 404 may detect, recognize, and/or identify an event 422 that triggers and/or activates a bonus feature 420 of electronic wagering game 418. In one example, bonus feature 420 may correspond and/or relate to metamorphic visuals 434(1)-(N) and/or a meter visual 436. In this example, event 422 may include and/or represent a random occurrence, a performance-driven occurrence, a wager-driven occurrence, and/or a time-driven occurrence. For example, event 422 may occur as a result of random number generation provided by an RNG. Additionally or alternatively, event 422 may occur as a result of a certain amount of time having elapsed since a previous bonus was awarded by electronic wagering game 418.

In some examples, circuitry 404 may detect, recognize, and/or identify at least one metric that represents the apparent and/or actual progress toward unlocking bonus feature 420 in connection with one or more of metamorphic visuals 434(1)-(N) and/or a meter visual 436. In such examples, circuitry 404 may direct display device 406 to render and/or modify metamorphic visuals 434(1)-(N) and/or meter visual 436, which correspond and/or relate to reels 426 and/or symbols 430, commensurate with the metric. In one example, the fill levels of metamorphic visuals 434(1)-(N) and/or meter visual 436 may not necessarily be to scale and/or commensurate with the user's actual progress toward and/or odds of unlocking bonus feature 420. For example, the fill levels of metamorphic visuals 434(1)-(N) and/or meter visual 436 may merely indicate and/or suggest the direction or trend of the user's progress (as opposed to the true magnitude of the user's progress) toward unlocking bonus feature 420. Additionally or alternatively, the fill levels may reflect a certain percentage and/or portion of the user's actual progress toward unlocking bonus feature 420.

In one example, circuitry 404 may direct display device 406 to stop the progress of one or more of metamorphic visuals 434(1)-(N) and/or meter visual 436 upon reaching a certain threshold (e.g., a 90% full state) in accordance with a perceived-persistence design, quasi-persistence design, and/or a pseudo-persistence design. In other words, the progress of one or more of metamorphic visuals 434(1)-(N) and/or meter visual 436 may essentially be capped and/or limited at a certain fill level. In this example, the progress may remain stagnant at the capped and/or limited fill level until bonus feature 420 is unlocked and/or awarded.

In one example, this metric may include and/or represent a counter that tracks and/or corresponds to the amount of time that has elapsed since the last time a certain bonus (e.g., a free-games feature) was awarded by electronic wagering game 418. Additionally or alternatively, this metric may include and/or represent a counter that tracks and/or corresponds to the number of certain symbols (e.g., COR symbols) that land on the reels during the base mode and/or bonus feature 420. In certain implementations, circuitry 404 may detect event 422 by determining that the metric has reached a certain threshold for awarding bonus feature 420 during the base mode.

In some examples, circuitry 404 may implement and/or execute bonus feature 420 of electronic wagering game 418 in response to event 422. In one example, bonus feature 420 may include and/or represent a free-games feature awarded and/or granted to the user during gameplay. In this example, the free-games feature may include and/or represent a game mechanic in which the user is awarded and/or granted a certain number of spins (e.g., 3 spins, 5 spins, 8 spins, etc.). For example, circuitry 404 may allot a certain number of spins of reels 426 to the user in connection with the free-games feature. Circuitry 404 may later terminate the free-games feature upon determining that the user has completed all the spins allotted to the user.

During bonus feature 420, each spin of reels 426 may render and/or display certain symbols (e.g., COR symbols and/or non-COR symbols). In one example, if reels 426 render and/or display one or more COR symbols during a spin, the COR symbols may be available to land again during subsequent spins of bonus feature 420. In some examples, circuitry 404 may implement and/or perform a collection of a total value 438 of COR symbols that land at the end of each free-games spin.

In some examples, circuitry 404 may direct and/or cause display device 406 to render and/or present one or more animations 432 corresponding to event 422. For example, circuitry 404 may direct and/or cause display device 406 to animate one or more of symbols 430, metamorphic visuals 434(1)-(N), and/or meter visual 436 in graphical interface 428 to indicate that bonus feature 420 has been awarded to the user. Additionally or alternatively, circuitry 404 may direct and/or cause display device 406 to animate one or more of symbols 430, metamorphic visuals 434(1)-(N), and/or meter visual 436 in graphical interface 428 to indicate that bonus feature 420 has ended and/or that total value 438 has been awarded and/or attributed to the user. In one example, animations 432 may communicate and/or convey, to the user, that event 422 has occurred. Additionally or alternatively, circuitry 404 may direct and/or cause display device 406 to animate one or more of symbols 430, metamorphic visuals 434(1)-(N), and/or meter visual 436 in graphical interface 428 to indicate that the user is getting closer to being awarded bonus feature 420.

In some examples, circuitry 404 may detect, prior to the implementation of bonus feature 420, one or more of symbols 430 during a spin of reels 426. In such examples, event 422 may include and/or involve determining that such symbols detected during the spin have increased a symbol count beyond a threshold. In one example, circuitry 404 may detect one or more additional instances of such symbols on at least one of reels 426 during bonus feature 420 and to then direct display device 406 to render, in connection with metamorphic visuals 434(1), an amount visual that reflects a total amount to be awarded to a user based at least in part on the additional instances of such symbols detected during bonus feature 420. In this example, the total amount may increase and/or grow in accordance with the COR symbols that land on reels 426 throughout bonus feature 420.

In some examples, circuitry 404 may allot a certain number of spins to the user in connection with bonus feature 420. In one example, circuitry 404 may terminate bonus feature 420 upon determining that the user has completed the certain number of reel spins. In this example, circuitry 404 may attribute, to the user, a value corresponding to the total amount reflected by the amount visual upon termination of bonus feature 420.

In some examples, circuitry 404 may detect one or more additional instances of the symbols on at least one of reels 426 during bonus feature 420. In one example, circuitry 404 may direct display device 406 to render, in connection with one of reels 426, a multiplier visual that reflects a multiplier value applied to one or more other instances of the symbols that land on that reel during bonus feature 420. In this example, circuitry 404 may detect the other instances of the symbols on that reel during bonus feature 420 and to then increase the multiplier value reflected by the multiplier visual in response to the other instances of the symbols being detected during bonus feature 420. Additionally or alternatively, circuitry 404 may attribute, to a user, a value corresponding to the additional instances of the symbols and the other instances of the symbols as enhanced by the multiplier value.

In some examples, circuitry 404 may detect, prior to the implementation of bonus feature 420, activity that involves reels 426 and results from an interaction between a user and electronic wagering game 418. In one example, circuitry 404 may direct display device 406 to modify at least one of metamorphic visuals 434(1)-(N) prior to the implementation of bonus feature 420 based at least in part on the activity.

In some examples, metamorphic visuals 434(1)-(N) may include a plurality of graphical chests configured to fill with graphical objects (e.g., orbs) commensurate with the metric. In one example, circuitry 404 may modify the at least one of metamorphic visuals 434(1)-(N) by animating movement of one of symbols 430 that landed on one of reels 426 during a spin from that reel toward one of the graphical chests. In certain implementations, metamorphic visuals 434(1)-(N) may include a graphical structure whose color changes commensurate with the metric.

In some examples, event 422 may include and/or involve detecting a randomly generated number prior to the implementation of bonus feature 420 and/or determining that the randomly generated number matches a certain number associated with bonus feature 420. In one example, circuitry 404 may detect a metric that represents actual progress toward unlocking bonus feature 420 in connection with the meter visual and to then direct the display device to modify the meter visual commensurate with the metric.

In some examples, circuitry 404 may detect, prior to the implementation of bonus feature 420, symbols of multiple types that land on reels 426 during a spin. In such examples, event 422 may include and/or involve determining that the symbols of the multiple types detected during the spin have increased symbol counts corresponding to the multiple types beyond a certain threshold.

In some examples, circuitry 404 may detect an additional symbol on one of reels 426 during bonus feature 420 and to then direct display device 406 to expand at least one dimension (e.g., height) of reels 426 to increase the number of winning positions available on reels 426 during subsequent spins based at least in part on the additional symbol. In one example, circuitry 404 may detect one or more other symbols on reels 426 during bonus feature 420 and to then implement an additional bonus feature in conjunction with bonus feature 420 in response to detecting the other symbols. For example, circuitry 404 may direct display device 406 to expand the height of reels 426 from a 3-by-5 configuration to a 4-by-5 or 5-by-5 configuration during a bonus feature in which a multiplier visual is applied to and/or over one of reels 426. In this example, circuitry 404 may direct display device 406 to raise the multiplier visual to the top of the corresponding reel as the height of reels 426 expands such that the multiplier visual remains atop that reel despite the expansion. Alternatively, circuitry 404 may direct display device 406 to maintain the multiplier visual in place on the corresponding reel as the height of reels 426 expands such that the multiplier visual overlays a middle portion of that reel upon expansion.

In some examples, circuitry 404 may include and/or represent one or more electrical and/or electronic circuits capable of processing, applying, modifying, transforming, displaying, transmitting, receiving, and/or executing data for system 400. Circuitry 404 may be communicatively and/or electrically coupled to display device 406. In one example, circuitry 404 may access and/or analyze data stored in memory to facilitate and/or support activating and/or controlling visually thematic bonus features of electronic wagering games. Additionally or alternatively, circuitry 404 may launch, perform, and/or execute certain executable files, code snippets, and/or computer-readable instructions to facilitate and/or support activating and/or controlling visually thematic bonus features of electronic wagering games. In certain implementations, circuitry 404 may provide display device 406 with instructions and/or commands that, upon execution, cause display device 406 to present and/or modify graphical interface 428 in accordance with the progression of electronic wagering game 418.

Although illustrated as a single unit in FIG. 4, circuitry 404 may include and/or represent a collection of multiple processing units and/or electrical or electronic components that work and/or operate in conjunction with one another. In one example, circuitry 404 may include and/or represent a central processing unit (CPU) and/or a graphics processing unit (GPU). In another example, circuitry 404 may include and/or represent an application-specific integrated circuit (ASIC). In certain implementations, circuitry 404 may be included and/or incorporated in an EGM and/or a mobile device, such as a smart phone. Additionally or alternatively, circuitry 404 may be included and/or incorporated in a server and/or one or more client devices of system 400. Examples of circuitry 404 include, without limitation, processing devices, microprocessors, microcontrollers, GPUs, CPUs, ASICs, field-programmable gate arrays (FPGAs), systems on chips (SoCs), hardware-based RNGs, software-based RNGs, parallel accelerated processors, tensor cores, integrated circuits, chiplets, optical modules, receivers, transmitters, transceivers, storage devices, memory devices, logical circuitry, portions of one or more of the same, variations or combinations of one or more of the same, and/or any other suitable circuitry.

In some examples, the various devices, components, and/or features described in connection with FIG. 4 may include and/or represent one or more additional circuits, components, and/or features that are not necessarily illustrated and/or labeled in FIG. 4. For example, the systems, components, and/or features illustrated in FIG. 4 may also include and/or represent additional analog and/or digital circuitry, onboard logic, transistors, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, combinations or variations of one or more of the same, and/or any other suitable components. In certain implementations, one or more of these additional circuits, components, and/or features may be inserted and/or applied between any of the existing circuits, components, and/or features illustrated in FIG. 4 consistent with the aims and/or objectives described herein. Accordingly, the couplings and/or connections described with reference to FIG. 4 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

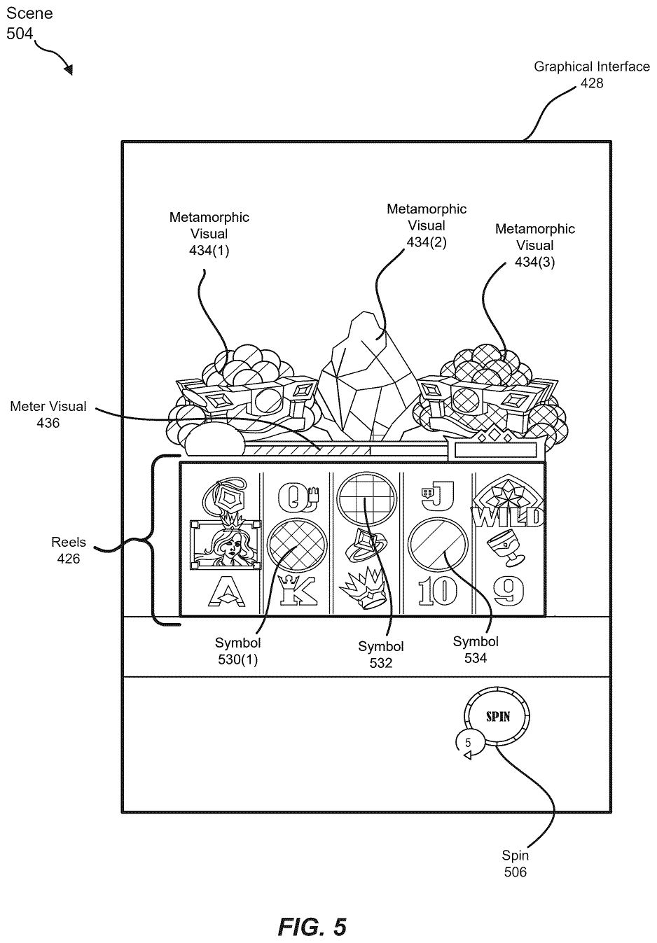

FIGS. 5-22 illustrate exemplary implementations of graphical interface 428 presented via display device 406. Specifically, FIGS. 5-22 illustrate different scenes of gameplay rendered by graphical interface 428 via display device 406. In some examples, graphical interface 428 may include and/or represent certain elements, components, and/or features that perform and/or provide functionalities that are similar and/or identical to those described above in connection with any of FIGS. 1-4. For example, graphical interface 428 may include and/or represent metamorphic visuals 434(1)-(N), meter visual 436, and/or various symbols on reels 426.

In some examples, metamorphic visuals 434(1)-(N) and/or meter visual 436 may include and/or represent the apparent and/or actual progress of a user toward unlocking bonus feature 420. In one example, circuitry 404 may detect and/or monitor metrics associated with and/or corresponding to metamorphic visuals 434(1)-(N) and/or meter visual 436. Additionally or alternatively, circuitry 404 may direct display device 406 to modify metamorphic visuals 434(1)-(N) and/or meter visual 436 with such metrics.

In some examples, circuitry 404 may detect and/or monitor activity that involves and/or relates to reels 426 prior to, during, and/or after the implementation of base mode and/or bonus feature 420. In one example, the activity may result from and/or be caused by one or more interactions (such as wagers) between the user and/or electronic wagering game 418. Additionally or alternatively, circuitry 404 may direct display device 406 to modify metamorphic visuals 434(1)-(N) and/or meter visual 436 commensurate with the metrics. In this example, the metrics may correspond to and/or represent durations and/or amounts of time since the last time a certain bonus (e.g., bonus feature 420) was awarded to the user in connection with metamorphic visuals 434(1)-(N) and/or meter visual 436, respectively. In certain implementations, metamorphic visuals 434(1)-(N) and/or meter visual 436 may reflect and/or represent the metrics, respectively. For example, metamorphic visuals 434(1)-(N) may include and/or represent a component or feature that reflects the durations or amounts of time since bonus feature 420 was awarded to the user in connection with metamorphic visuals 434(1)-(N).

As a specific example, metamorphic visual 434(1) may include and/or represent a graphical representation of a chest of one color, metamorphic visual 434(3) may include and/or represent a graphical representation of a chest of another color, and/or metamorphic visual 434(2) may include and/or represent a graphical representation of a crystal structure. In this example, metamorphic visuals 434(1) and 434(3) may each include and/or represent a graphical representation of a chest that fills with graphical objects (e.g., orbs) commensurate with certain metrics (e.g., the amount of time since the corresponding bonus features were last awarded by electronic wagering game 418). Additionally or alternatively, metamorphic visuals 434(1) and 434(3) may each reflect and/or represent an amount of gameplay, the number of wagers made since the last corresponding bonus feature was awarded, and/or the number of spins played since the last corresponding bonus feature was awarded.

FIGS. 5-10 illustrate various exemplary scenes of gameplay implemented and/or executed by circuitry 404 in electronic wagering game 418. Such scenes may demonstrate and/or represent a progression of gameplay that leads to and/or includes one or more bonus features provided and/or offered by electronic wagering game 418.

As illustrated in FIG. 5, the graphical chests represented by metamorphic visuals 434(1) and 434(3) may fill with graphical objects as time elapses since the last instance of bonus feature 420 was awarded and/or granted. In certain implementations, the time relevant to metamorphic visuals 434(1) and 434(3) may elapse over a single game and/or a single wagering cycle. In other implementations, the time relevant to metamorphic visuals 434(1) and 434(3) may elapse over multiple games and/or multiple wagering cycles. In one example, the user may perform and/or induce a spin 506 of reels 426.

In some examples, circuitry 404 may award and/or grant an instance of bonus feature 420 to the user based at least in part on random number generation provided by an RNG. In one example, circuitry 404 may detect a randomly generated number provided by the RNG prior to the implementation of bonus feature 420. In this example, circuitry 404 may determine that the randomly generated number matches a certain number associated with bonus feature 420.

In some examples, circuitry 404 may direct and/or cause display device 406 to render and/or present animations 432 in connection with event 422 by animating one or more of metamorphic visuals 434(1)-(N), meter visual 436, and/or symbols 430. For example, if bonus feature 420 is awarded in connection with metamorphic visual 434(1), circuitry 404 may direct and/or cause symbol 534 to launch and/or shoot from reels 426 toward metamorphic visual 434(1). In one example, if bonus feature 420 is awarded in connection with metamorphic visual 434(3), circuitry 404 may direct and/or cause a symbol 530(1) to launch and/or shoot from reels 426 toward metamorphic visual 434(3). In certain implementations, if bonus feature 420 is awarded in connection with both of metamorphic visuals 434(1) and 434(3) simultaneously, circuitry 404 may direct and/or cause symbols 530(1) and 534 to launch and/or shoot from reels 426 toward metamorphic visuals 434(3) and 434(1), respectively. Additionally or alternatively, if bonus feature 420 is awarded in connection with metamorphic visual 434(2), circuitry 404 may direct and/or cause symbol 532 to launch and/or shoot from reels 426 toward metamorphic visual 434(2).

As illustrated in FIGS. 5-10, graphical interface 428 may render and/or show scenes 504, 604, 704, 804, 904, and 1004 in connection with electronic wagering game 418. In one example, scenes 504, 604, 704, 804, 904, and 1004 may constitute and/or represent an exemplary transition from a base mode to bonus feature 420. In this example, circuitry 404 may direct and/or cause display device 406 to display, present, and/or implement scenes 504, 604, 704, 804, 904, and 1004 in graphical interface 428.

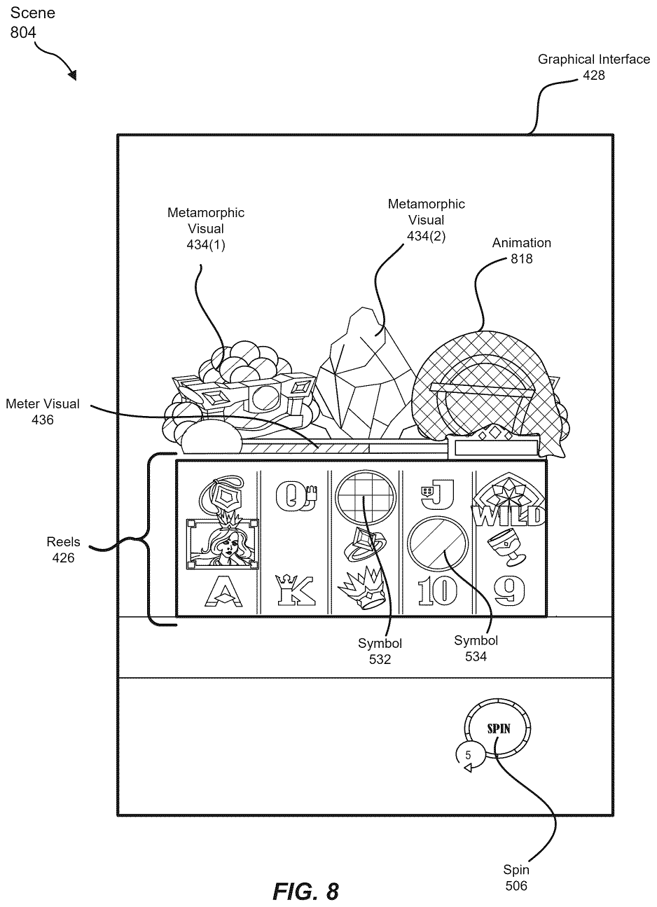

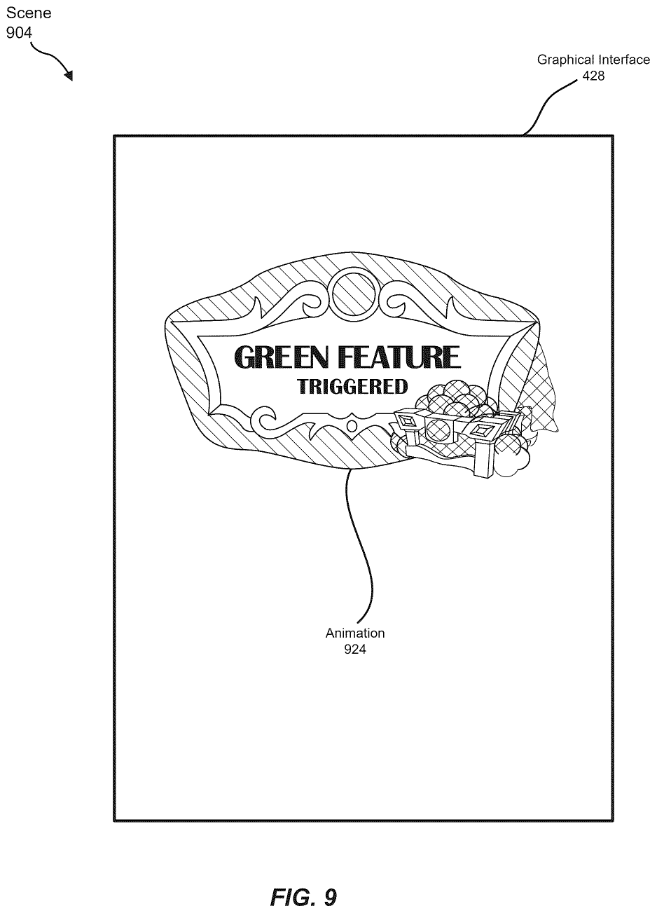

As illustrated in scenes 504, 604, 704 in FIGS. 5-7, a symbol 530(1) that lands on reels 426 during the base mode of electronic wagering game 418 may launch and/or shoot from reels 426 toward metamorphic visual 434(3) as an animation 616. In one example, as illustrated in scene 804 in FIG. 8, upon reaching and/or hitting metamorphic visual 434(3), symbol 530(1) may cause and/or generate a graphical explosion or illumination on or around metamorphic visual 434(3) as an animation 818. In this example, as illustrated in scene 904 in FIG. 9, an animation 924 may appear and/or present in graphical interface 428 after completion of animation 818. Additionally or alternatively, animation 924 may show and/or indicate that bonus feature 420 has been triggered in part by symbol 530(1) landing on reels 426.

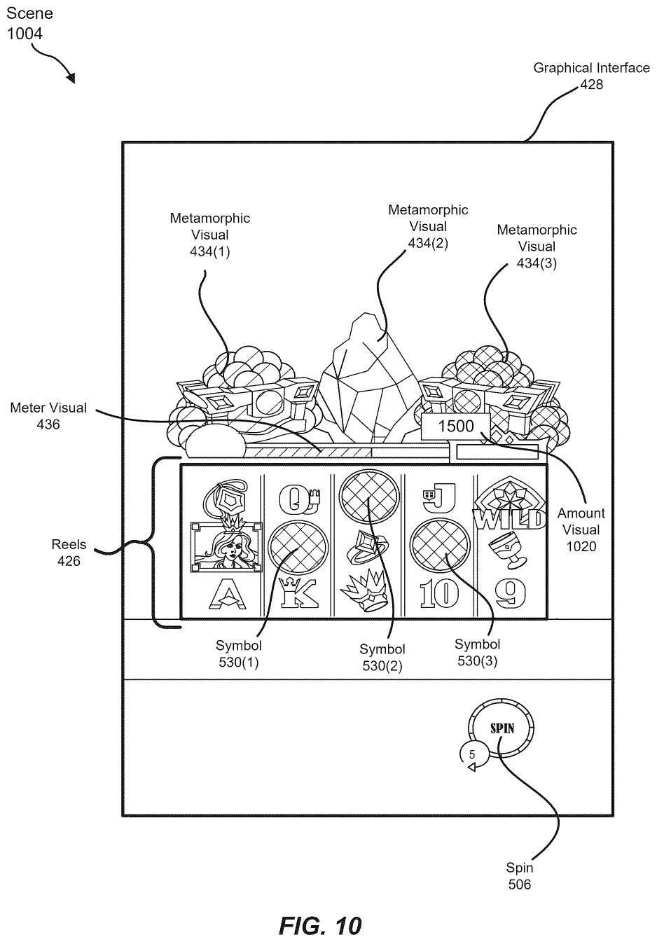

In some examples, as illustrated in scene 1004 in FIG. 10, bonus feature 420 may begin and/or appear in graphical interface 428 after completion of event 422. In one example, bonus feature 420 may involve converting any COR symbols (e.g., COR symbols of different colors) that landed on reels 426 into COR symbols of a single color because bonus feature 420 is directed exclusively to such single-color COR symbols. For example, in scene 1004, symbols 532 and 534 may convert and/or transform into symbols 530(2) and 530(3), respectively. In this example, bonus feature 420 may begin with an initial value commensurate with symbols 530(1)-(3), which were either held over and/or converted from the base mode. In certain implementations, bonus feature 420 may involve depicting an amount visual 1020 that reflects the total value to be awarded to the user based at least in part on symbols 530(1)-(3). Accordingly, bonus feature 420 may correspond to and/or be associated with instances of symbol 530.

In some examples, bonus feature 420 may involve and/or implement gameplay similar to the base mode. However, in one example, bonus feature 420 may increase the value of the single-color COR symbols every time they land during a spin. For example, bonus feature 420 may involve and/or implement rolling up the value of single-color COR symbols, thereby rendering a so-called super value and/or award. In this example, the super value and/or award may include and/or represent a running total and/or value that continually accumulates and/or is rolled up relative to the previous value and/or a subsequent COR symbol. Accordingly, the super value and/or award may include and/or represent a cumulative sum of single-color COR values that is updated based on the addition of each new single-color COR symbol that lands during bonus feature 420.

In some examples, upon landing during a spin of bonus feature 420, a single-color COR symbol may have an initial value that gets rolled up into a super value and/or award that is applied to subsequent occurrences of the single-color COR symbol. In one example, upon landing during a subsequent spin of bonus feature 420, the single-color COR symbol may assume and/or take on the super value and/or award, which was increased relative to the initial value of the single-color COR symbol. In this example, a subsequent occurrence of the single-color COR symbol may have a value equivalent to the accumulated super value and/or award. Accordingly, the occurrences of the single-color COR symbol may cause and/or result in large rollup super values and/or awards.

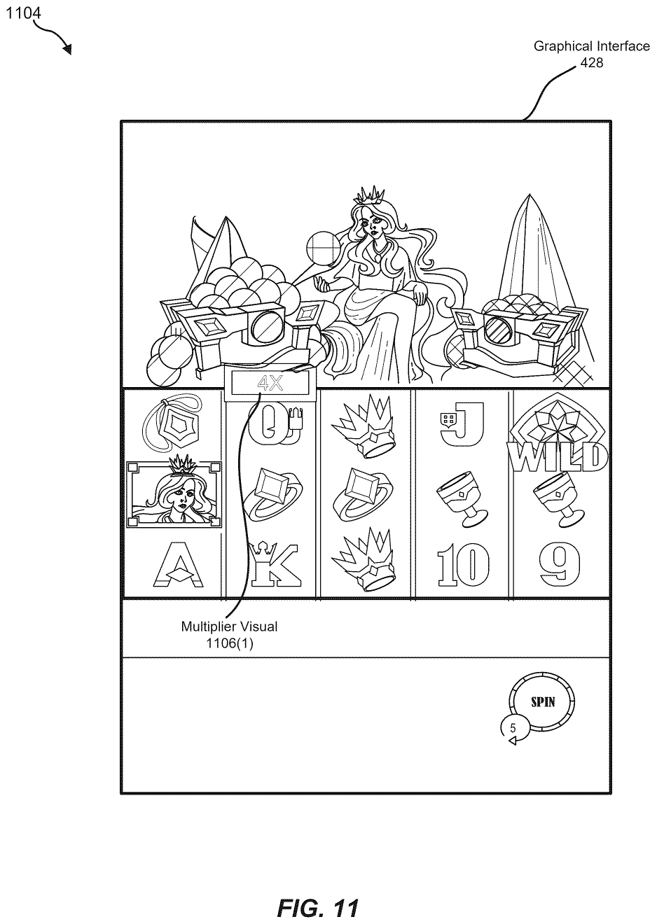

As illustrated in FIGS. 11-15, graphical interface 428 may render and/or show scenes 1104, 1204, 1304, 1404, and 1504 in connection with electronic wagering game 418. In one example, scenes 1104, 1204, 1304, 1404, and 1504 may constitute and/or represent a gameplay implementation of bonus feature 420 and/or an exemplary progression through bonus feature 420. In this example, circuitry 404 may direct and/or cause display device 406 to display, present, and/or implement scenes 504, 604, 704, 804, 904, and 1004 in graphical interface 428. In some examples, bonus feature 420 may correspond to and/or be associated with instances of symbol 534.

As illustrated in scenes 1104, 1204, and 1304 in FIGS. 11-13, symbols 534(1)-(2) may land on reels 426 during a spin of bonus feature 420. Prior to the spin, a multiplier visual 1106(1) may be applied to and/or over one of reels 426 in scene 1104. In one example, multiplier visual 1106(1) may reflect and/or indicate a multiplier value to be applied to any instances of symbol 534 that land on that reel during a subsequent spin. During the spin, symbol 534(1) may land on that reel, thereby causing the value of symbol 534(1) to be increased by the multiplier value of multiplier visual 1106(1). In this example, the multiplier value of multiplier visual 1106(1) may also be increased (e.g., doubled) in response to symbol 534(1) landing on that reel during the spin. For example, after symbol 534(1) lands on that reel, the multiplier value of multiplier visual 1106(1) may increase from “4×” to “8×,” as depicted across scenes 1204 and 1304.

During the spin, symbol 534(2) may land on another of reels 426, thereby causing the creation of multiplier visual 1106(2) on that other reel. For example, after symbol 534(2) lands on that other reel, the multiplier value of multiplier visual 1106(2) may be introduced at “4×,” as depicted across scenes 1204 and 1304. During a subsequent spin, symbol 534(4) may land on the other reel, thereby causing the value of symbol 534(4) to be increased by the multiplier value of multiplier visual 1106(2). In this example, the multiplier value of multiplier visual 1106(2) may be increased (e.g., doubled) in response to symbol 534(4) landing on that other reel during the spin. For example, after symbol 534(4) lands on that other reel, the multiplier value of multiplier visual 1106(2) may increase from “4×” to “8×,” as depicted across scenes 1304 and 1404. Also during the subsequent spin, symbol 534(3) may land on an additional one of reels 426, thereby causing the creation of multiplier visual 1106(3) on that additional reel. For example, after symbol 534(3) lands on that additional reel, the multiplier value of multiplier visual 1106(3) may be introduced at “4×,” as depicted in scene 1404.

In some examples, bonus feature 420 may reach a termination 1524 in scene 1504 after the user takes all the spins allotted to the user for bonus feature 420. In one example, scene 1504 may display and/or present a value 1512 that is attributed to the user upon termination 1524 of bonus feature 420. In this example, value 1512 may correspond to, account for, and/or represent all symbols 534(1)-(4) as enhanced by the multiplier value.

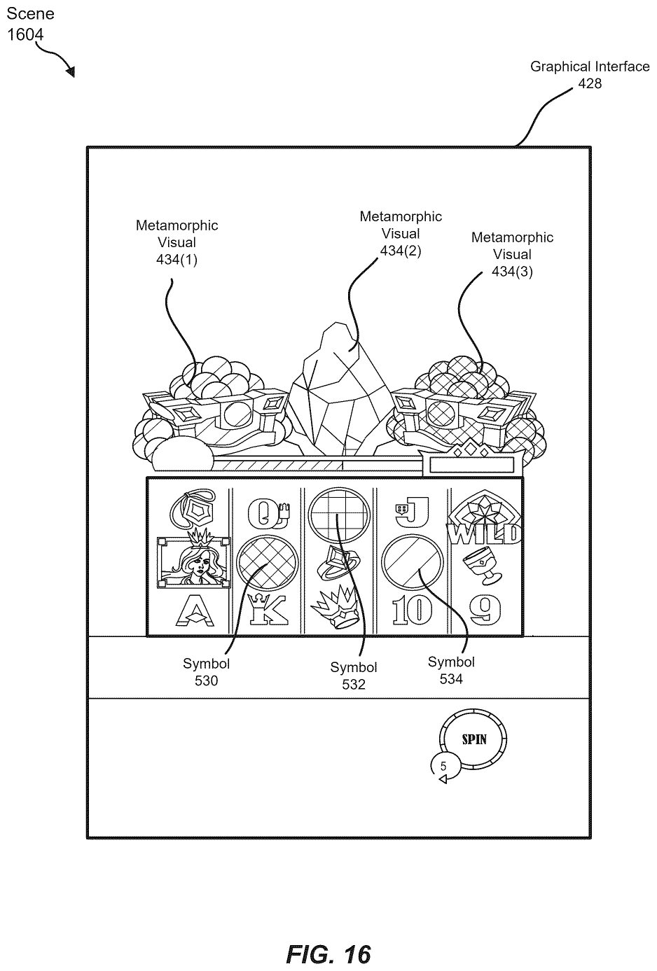

As illustrated in FIGS. 16-19, graphical interface 428 may render and/or show scenes 1604, 1704, 1804, and 1904 in connection with electronic wagering game 418. In one example, scenes 1604, 1704, 1804, and 1904 may constitute and/or represent an exemplary transition from a base mode to bonus feature 420. In this example, circuitry 404 may direct and/or cause display device 406 to display, present, and/or implement scenes 1604, 1704, 1804, and 1904 in graphical interface 428. In certain implementations, bonus feature 420 may begin with an animation 1924. In such implementations, animation 1924 may show and/or indicate that a bonus feature corresponding to symbol 532 has been triggered.

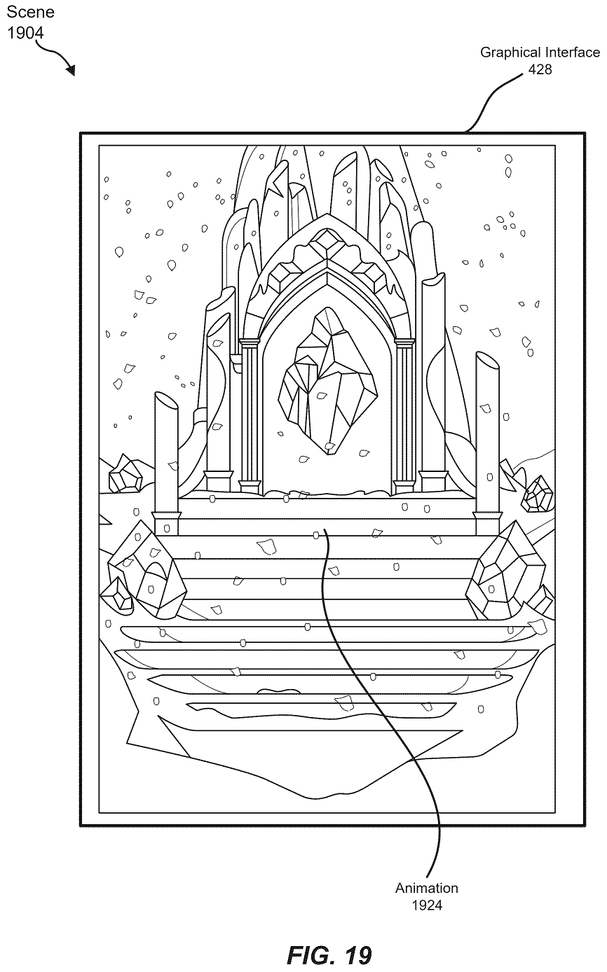

As illustrated in scenes 1604, 1704, and 1804 in FIGS. 16-18, symbol 532 that lands on reels 426 during the base mode of electronic wagering game 418 may launch and/or shoot from reels 426 toward metamorphic visual 434(2) as an animation 1716. In one example, as symbol 532 reaches and/or hits metamorphic visual 434(2), metamorphic visual 434(2) may achieve and/or perform a color change 1818 indicating that the bonus feature corresponding to symbol 532 has been triggered. In this example, as illustrated in scene 1904 in FIG. 19, an animation 1924 may appear and/or present in graphical interface 428 after completion of color change 1818. Additionally or alternatively, animation 1924 may show and/or indicate that the bonus feature has been triggered in part by symbol 532 landing on reels 426. In this example, the bonus feature may correspond to and/or be associated with symbol 532.

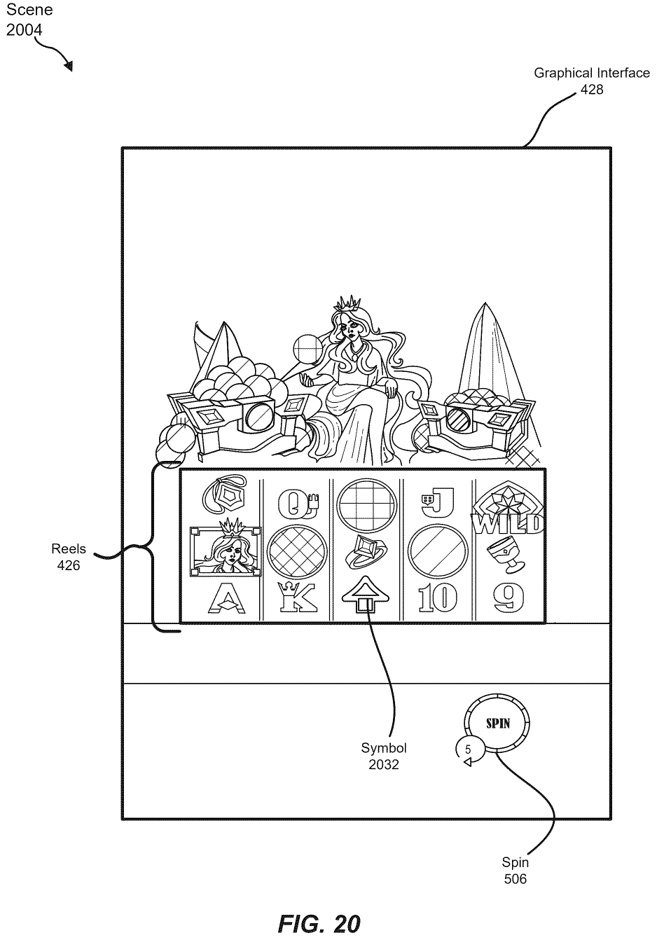

As illustrated in FIGS. 20-22, graphical interface 428 may render and/or show scenes 2004, 2104, and 2204 in connection with electronic wagering game 418. In one example, scenes 2004, 2104, and 2204 may constitute and/or represent an exemplary progression through bonus feature 420. In this example, circuitry 404 may direct and/or cause display device 406 to display, present, and/or implement scenes 2004, 2104, and 2204 in graphical interface 428.

As illustrated in scenes 2004, 2104, and 2204 in FIGS. 20-22, a symbol 2032 may land on reels 426 during a spin of bonus feature 420. In response, reels 426 may expand and/or grow in height, thereby increasing the number of winning positions available on reels 426 during subsequent spins based at least in part on symbol 2032. In other words, if symbol 2032 lands on one of reels 426 during bonus feature 420, symbol 2032 may cause reels 426 to grow and/or expand from a set of 3-by-5 reels as depicted in scene 2004 to, for example, a set of 4-by-5 reels as depicted in scene 2104 or a set of 5-by-5 reels as depicted in scene 2204. As a result, the expanded set of reels may provide more positions on which COR symbols may land during subsequent spins of bonus feature 420, thereby offering the user better odds of winning.

In some examples, bonus feature 420 may include and/or represent a frenzy mode. In one example, during implementation of bonus feature 420, circuitry 404 may additionally award and/or implement a further bonus mode and/or feature, including any of those described above in connection with one or more of FIGS. 1-19. In this example, as a result, circuitry 404 may execute and/or implement a further bonus mode and/or feature within bonus feature 420. In certain implementations, such a bonus-within-another-bonus mode may be played out and/or implemented on an expanded set of reels provided in bonus feature 420.

In some examples, circuitry 404 may rely on random number generation in conjunction with the user's wager and/or a weighted lookup table stored in memory to facilitate and/or support gameplay of bonus feature 420 in accordance with a suitable RTP. For example, the symbols rendered on reels 426 may land as a result of one or more random numbers generated by an RNG. In this example, the configuration and/or arrangement of such symbols may correspond to and/or represent a certain outcome. This outcome may lead to and/or result in a certain payout or none at all depending on the parameters of the weighted lookup table. Additionally or alternatively, this outcome may be modified and/or enhanced by the amount of the user's wager in accordance with the weighted lookup table.

In some examples, circuitry 404 may determine and/or identify the user's eligibility for bonus feature 420 and/or the rules for implementing bonus feature 420 based at least in part on the parameters of the weighted lookup table. In one example, circuitry 404 may determine and/or identify the appropriate payout for the user based at least in part on the user's wager applied to bonus feature 420 and/or the parameters of the weighted lookup table. In this example, circuitry 404 may apply and/or award that payout to the user in accordance with bonus feature 420.

In some examples, to be eligible for bonus feature 420, the user may need to wager a Tier-2 bet. In one example, circuitry 404 may evaluate, calculate, and/or compute the average wager made by the user across all eligible Tier-2 wagers prior to triggering bonus feature 420. In this example, circuitry 404 may reset and/or recalculate the average wager after every instance of the bonus features implemented in electronic wagering game 418.

In some examples, circuitry 404 may limit the available wagers in bonus feature 420 based on the calculated average. For example, circuitry 404 may prevent and/or preclude the user from making any wagers greater than the user's average bet. As a specific example, if the list of available Tier-2 wagers are 100, 200, 400, 500, and/or 1,000 credits. In this example, the user has played 10 spins at 100 credits and 10 spins at 500 credits prior to triggering bonus feature 420. In view of these observations, circuitry 404 may calculate the user's average wager to be 300 credits. Accordingly, circuitry 404 may limit the available wagers to those under 300 credits (e.g., 100 and 200 credits) during bonus feature 420.

In some examples, circuitry 404 may utilize and/or implement a scale factor to mitigate any delta RTP loss experienced due to the user's inability to make the calculated average wager during bonus feature 420. In one example, circuitry 404 may apply this scale factor to all credit COR wins within bonus feature 420. However, in this example, circuitry 404 may refrain from applying this scale factor to the values of symbol 530, ways wins, and/or jackpot wins.

In one example, the scale factor may be determined, calculated, and/or computed via the following formula:

$$scale factor = \frac{\begin{matrix}average bet \times ( bonus RTP - base RTP ) + actual bet \times \\ base RTP \times bonus hit rate + bonus RTP \times bonus spins\end{matrix}}{actual bet \times base RTP \times ( bonus hit rate + bonus spins )} .$$

In this example, circuitry 404 may determine, calculate, and/or compute the average bet and/or the actual bet per play session. However, the bonus hit rate, the bonus RTP, the base RTP, and/or the bonus spins may all be constants that remain the same regardless of the play session. In certain implementations, the RTPs may differ and/or vary from one play session to another.

In one example, the scale factor may be truncated to the nearest tenth (e.g., from 1.58 to 1.5) and then applied to all instances of symbol 532. In this example, if the user has maintained the same Tier-2 bet throughout the base mode, the scale factor may be set to 1. In certain implementations, circuitry 404 may calculate the scale factor by assuming that the user is playing the highest available bet in bonus feature 420. For example, if the user's average wager in the base mode is 300, then circuitry 404 may calculate the scale factor by assuming that the user is betting 200 for every spin in bonus feature 420. In this example, circuitry 404 may apply the scale factor to every bet placed by the user during bonus feature 420. If the user decides to bet 100 for a spin in bonus feature 420, then circuitry 404 may apply a previously calculated scalar instead of recalculating the scale factor for lesser bets.

FIG. 23 is a flow diagram of an exemplary computer-implemented method 2300 for controlling visually thematic bonus features of electronic wagering games. In one example, the steps shown in FIG. 23 may be achieved and/or accomplished by an EGM and/or a server implementing an electronic wagering game. Additionally or alternatively, the steps shown in FIG. 23 may incorporate and/or involve certain sub-steps and/or variations consistent with the descriptions provided above in connection with FIGS. 1-22.

As illustrated in FIG. 23, method 2300 may include the step of directing, by circuitry included in a computing system, a display device to render a plurality of metamorphic visuals and a meter visual that correspond to reels of an electronic wagering game in a graphical user interface (2302). Step 2302 may be performed in a variety of ways, including any of those described above in connection with FIGS. 1-22. For example, circuitry included in a mobile device may direct a display device to render a plurality of metamorphic visuals and a meter visual that correspond to reels of an electronic wagering game in a graphical user interface.

Method 2300 may also include the step of detecting, by the circuitry, an event that (1) triggers a bonus feature of the electronic wagering game in connection with at least one of the plurality of metamorphic visuals or the meter visual and (2) is based at least in part on a randomly generated number provided by an RNG (2304). Step 2304 may be performed in a variety of ways, including any of those described above in connection with FIGS. 1-22. For example, the circuitry may detect an event that (1) triggers a bonus feature of the electronic wagering game in connection with at least one of the plurality of metamorphic visuals or the meter visual and (2) is based at least in part on a randomly generated number provided by an RNG (2304).

Method 2300 may further include the step of implementing, by the circuitry in response to detecting the event, the bonus feature in accordance with a weighted lookup table stored in memory (2306). Step 2306 may be performed in a variety of ways, including any of those described above in connection with FIGS. 1-22. For example, the circuitry may implement, in response to detecting the event, the bonus feature in accordance with a weighted lookup table stored in memory.

In some examples, one or more of the components, features, and/or devices illustrated in FIGS. 1-23 need not be present to practice the embodiments described and/or illustrated herein. The components, features, and/or devices referenced above may also be interconnected in different ways from those shown in FIGS. 1-23. One or more of the components, features, and/or devices may be employed in any number of software, firmware, and/or hardware configurations. For example, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into one of the components, features, and/or devices in FIGS. 1-23. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein are implemented in firmware and/or hardware. For example, one or more of the devices and/or subsystems in FIGS. 1-23 is configured as an ASIC adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a display device; and
circuitry configured to:
direct the display device to render, in a graphical interface of an electronic wagering game, a plurality of metamorphic visuals and a meter visual that correspond to reels of the electronic wagering game;
detect an event that:
triggers a bonus feature of the electronic wagering game in connection with at least one of the plurality of metamorphic visuals and the meter visual; and
is based at least in part on a randomly generated number provided by a random number generator (RNG); and
implement, in response to detecting the event, the bonus feature in accordance with a weighted lookup table stored in memory.

2. The system of claim 1, wherein the circuitry is further configured to detect, prior to the implementation of the bonus feature, one or more symbols of a certain type during a spin of the reels, wherein the event comprises determining that the symbols of the certain type detected during the spin have increased a symbol count beyond a threshold.

3. The system of claim 2, wherein the circuitry is further configured to:
detect one or more additional instances of the symbols on at least one of the reels during the bonus feature; and
direct the display device to render, in connection with the metamorphic visual, an amount visual that reflects a total amount to be awarded to a user based at least in part on the additional instances of the symbols detected during the bonus feature.

4. The system of claim 3, wherein the circuitry is further configured to:
allot a certain number of spins to the user in connection with the bonus feature; and
terminate the bonus feature upon determining that the user has completed the certain number of spins.

5. The system of claim 4, wherein the circuitry is further configured to attribute, to the user, a value corresponding to the total amount reflected by the amount visual upon termination of the bonus feature.

6. The system of claim 2, wherein the circuitry is further configured to:
detect one or more additional instances of the symbols on at least one of the reels during the bonus feature; and
direct the display device to render, in connection with the at least one of the reels, a multiplier visual that reflects a multiplier value applied to one or more other instances of the symbols that land on the at least one of the reels during the bonus feature.

7. The system of claim 6, wherein the circuitry is further configured to:
detect the other instances of the symbols on the at least one of the reels during the bonus feature; and
increase the multiplier value reflected by the multiplier visual in response to the other instances of the symbols being detected during the bonus feature.

8. The system of claim 6, wherein the circuitry is further configured to attribute, to a user, a value corresponding to the additional instances of the symbols and the other instances of the symbols as enhanced by the multiplier value.

9. The system of claim 1, wherein the circuitry is further configured to:
detect, prior to the implementation of the bonus feature, activity that involves the reels and results from an interaction between a user and the electronic wagering game; and
direct the display device to modify at least one of the metamorphic visuals prior to the implementation of the bonus feature based at least in part on the activity.

10. The system of claim 9, wherein the circuitry is further configured to:
detect at least one metric that represents apparent progress toward unlocking the bonus feature in connection with the at least one of the metamorphic visuals; and
direct the display device to modify the at least one of the metamorphic visuals commensurate with the metric.

11. The system of claim 10, wherein the metric represents at least one of:
an amount of time since the electronic wagering game last awarded a previous instance of the bonus feature; or
a count of certain symbols that land during spins of the reels.

12. The system of claim 10, wherein:
the metamorphic visuals comprise a plurality of graphical chests configured to fill with graphical objects commensurate with the metric; and
the circuitry is further configured to modify the at least one of the metamorphic visuals by animating movement of a symbol that landed on one of the reels during a spin from the one of the reels toward one of the graphical chests.

13. The system of claim 10, wherein the metamorphic visuals comprise a graphical structure whose color changes commensurate with the metric.

14. The system of claim 1, wherein the event comprises:
detecting the randomly generated number prior to the implementation of the bonus feature; and
determining that the randomly generated number matches a certain number associated with the bonus feature.

15. The system of claim 1, wherein the circuitry is further configured to:
detect at least one metric that represents actual progress toward unlocking the bonus feature in connection with the meter visual; and
direct the display device to modify the meter visual commensurate with the metric.

16. The system of claim 1, wherein the circuitry is further configured to detect, prior to the implementation of the bonus feature, symbols of multiple types during a spin of the reels, wherein the event comprises determining that the symbols of the multiple types detected during the spin have increased symbol counts corresponding to the multiple types beyond at least one threshold.

17. The system of claim 1, wherein the circuitry is further configured to:
detect an additional symbol on at least one of the reels during the bonus feature; and
direct the display device to expand at least one dimension of the reels to increase a number of positions available on the reels during subsequent spins based at least in part on the additional symbol.

18. The system of claim 17, wherein the circuitry is further configured to:
detect one or more other symbols on at least one of the reels during the bonus feature; and
implement an additional bonus feature in conjunction with the bonus feature in response to detecting the other symbols.

19. A computer-implemented method comprising:
directing, by circuitry included in a computing system, a display device to render a plurality of metamorphic visuals and a meter visual that correspond to reels of an electronic wagering game in a graphical user interface;
detecting, by the circuitry, an event that:
triggers a bonus feature of the electronic wagering game in connection with at least one of the plurality of metamorphic visuals and the meter visual; and
is based at least in part on a randomly generated number provided by a random number generator (RNG); and
implementing, by the circuitry in response to detecting the event, the bonus feature in accordance with a weighted lookup table stored in memory.

20. A non-transitory computer-readable medium comprising one or more computer-executable instructions that, when executed by at least one hardware processor of a computing device, cause the hardware processor to:
direct a display device to render a plurality of metamorphic visuals and a meter visual that correspond to reels of an electronic wagering game in a graphical user interface;
detect an event that:
triggers a bonus feature of the electronic wagering game in connection with at least one of the plurality of metamorphic visuals and the meter visual; and
is based at least in part on a randomly generated number provided by a random number generator (RNG); and
implement, in response to detecting the event, the bonus feature in accordance with a weighted table stored in memory.
